(19) United States
(12) Patent Application Publication
(10) Pub. No.: US 2025/0319494 A1
(43) Pub. Date: Oct. 16, 2025

(54) SYSTEMS AND METHODS FOR WASTE COLLECTION, HANDLING, AND/OR SORTING

(71) Applicant: rStream Recycling Inc., Somerville, MA (US)

(72) Inventors: Ian M. Goodine, Cambridge, MA (US); Ethan M. Walko, Somerville, MA (US); John T. Pierce, Cambridge, MA (US); Thomas M. Gable, Weymouth, MA (US)

(73) Assignee: rStream Recycling Inc., Somerville, MA (US)

(21) Appl. No.: 18/876,702

(22) PCT Filed: Jul. 6, 2023
(86) PCT No.: PCT/US2023/069731

§ 371 Date: Dec. 19, 2024

Related U.S. Application Data
(60) Provisional application No. 63/359,062, filed on Jul. 7, 2022.

(51) Int. Cl. B07C 5/36; B07C 5/342; B25J 9/16; B65G 47/38; B65G 47/51

(52) U.S. Cl. CPC B07C 5/365; B07C 5/3422; B07C 5/362; B65G 47/38; B65G 47/519; B07C 2501/0036; B07C 2501/0054; B07C 2501/0072; B07C 2501/0081; B25J 9/1697

(57) ABSTRACT

The present disclosure generally relates to collecting, handling, and/or sorting of waste or other objects. For example, certain embodiments are generally directed to systems and methods for collecting and sorting objects such as trash, recyclables, compostables, etc. In some cases, such systems may be used at a MRF (materials recovery facility), a transfer station, a public facility, or other locations where various objects in a waste stream are to be sorted. In some cases, the system may be relatively small and compact. The waste stream may be singulated or separated into discrete objects to facilitate identification and sorting. For example, two or more discrete objects within the waste stream that are contacting one another or are proximate to one another may be separated, so as to facilitate identification and/or sorting of the objects. This may be useful, for example, for producing less contaminated streams of trash, recyclables, compostables, etc. from a waste stream.

### CROSS REFERENCE TO RELATED APPLICATIONS

This application claims the benefit of priority under 35 U.S.C. § 119(e) of U.S. Provisional Application Ser. No. 63/359,062, filed Jul. 7, 2022, the disclosure of which is incorporated herein by reference in its entirety.

### FIELD

The present disclosure generally relates to collecting, handling, and/or sorting of waste or other objects.

### BACKGROUND

Sorting recyclable materials from waste is one of the biggest challenges currently facing society. A significant volume of recyclable materials are incinerated or discarded in landfills due to the lack of techniques to sort recyclable materials from non-recyclable materials. Some existing techniques for sorting recyclable materials are limited to their excessive cost, low accuracy, or inability to operate independently. For example, one sorting technique involves the use of robots that can identify and separate recyclable material from waste, but this approach often can be slow compared to hand-sorting items.

Waste can be classified into recyclable and non-recyclable materials. Recyclable materials may include materials such as paper, glass, plastic, and metal. These recyclable materials can be reconstituted into usable materials. Recyclable materials are typically collected via two main collection methods: single-stream recycling and multi-stream recycling. The use of single-stream recycling has simplified the recycling process for consumers, but it also put a strain on the recycling industry for developing cost-effective techniques to sort recyclables from trash. Thus, improvements are needed.

### SUMMARY

The present disclosure generally relates to collecting, handling, and/or sorting of waste or other objects. The subject matter of the present disclosure involves, in some cases, interrelated products, alternative solutions to a particular problem, and/or a plurality of different uses of one or more systems and/or articles. As such, it should be understood that the systems and methods described herein may be used separately or in conjunction with one another.

One aspect is generally directed to a system. In one set of embodiments, the system comprises a container for containing objects; a conveyor belt comprising a plurality of collectors, the conveyor belt positioned to collect an object from the container into a collector of the plurality of collectors; a receiver for receiving the object from the collector, wherein the receiver is at a height greater than an outlet of the container; and a rejection apparatus for preventing two or more objects contained within the collector from being received by the receiver.

In another set of embodiments, the system comprises a container for containing objects; a conveyor belt comprising a plurality of collectors having an average volume of less than 5,000 cm³, the conveyor belt positioned to collect objects from the container into a collector of the plurality of collectors; a camera positioned to image the collectors containing the objects; a processor in communication with the camera for determining a number of objects within the collector; and a rejection apparatus for removing objects from the collector if the processor determines two or more objects within the collector.

Another aspect is generally directed to a method. According to one set of embodiments, the method comprises acts of containing recyclables within a container; collecting the recyclables within a plurality of collectors on a conveyor belt; rejecting the recyclables in collectors containing two or more recyclables therein; conveying non-rejected recyclables in the collectors to a receiver, wherein the receiver is at a height greater than an outlet of the container; and sorting the non-rejected recyclables.

The method, in another set of embodiments, comprises containing recyclables within a container; collecting the recyclables within a plurality of collectors on a conveyor belt, the collectors having an average volume of less than 5,000 cm³; rejecting the recyclables in collectors containing two or more recyclables therein; and sorting the non-rejected recyclables.

In yet another set of embodiments, the method comprises containing recyclables within a container, wherein at least 50% by weight of the recyclables are cans or bottles; spacing the recyclables on a receiver to physically separate the recyclables such that 90% of the recyclables are separated by at least 5 cm; acquiring images of the recyclables on the receiver; and sorting the recyclables based at least in part on their images.

The method, in still another set of embodiments, comprises containing waste within a container, wherein at least 50% by weight of the waste are recyclables comprising glass, metal, or plastic; singulating the recyclables from the container onto a receiver; acquiring images of the recyclables on the receiver; and sorting the recyclables based on their images.

In a further set of embodiments, a system comprises a container for containing objects; a conveyor belt comprising a plurality of collectors, wherein the conveyor belt is configured to collect one or more objects from the container into a collector of the plurality of collectors; a receiver configured to receive the one or more objects from the collector, wherein the receiver is disposed at a vertical position that is greater than an outlet of the container; and a rejection apparatus, wherein the rejection apparatus is configured to selectively prevent the one or more objects contained within the collector from being received by the receiver.

In yet a further set of embodiments, a system comprises a container for containing objects; a conveyor belt comprising a plurality of collectors having an average volume of less than 5,000 cm³, wherein the conveyor belt is configured to collect objects from the container into a collector of the plurality of collectors; a camera configured to image one or more collectors of the plurality of collectors containing the objects; a rejection apparatus configured to selectively remove objects from the one or more collectors; and a processor configured to: obtain images from the camera; determine a number of objects within the one or more collectors based at least in part on the obtained images; and control the rejection apparatus to remove objects from the one or more collectors if the number of objects is two or more.

The method, in yet still another set of embodiments, comprises containing recyclables within a container, wherein at least 50% by weight of the recyclables are cans or bottles; spacing the recyclables on a receiver to physically separate the recyclables such that at least 90% of the recyclables are separated by at least 5 cm; acquiring images of the recyclables on the receiver; and sorting the recyclables based at least in part on the images.

In another aspect, the present disclosure encompasses methods of making one or more of the embodiments described herein, for example, a sorting system. In still another aspect, the present disclosure encompasses methods of using one or more of the embodiments described herein, for example, a sorting system.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 illustrates a sorting system for use with certain embodiments;

FIG. 2 illustrates a schematic of a separation apparatus having an inclined belt, according to some embodiments;

FIG. 3. illustrates a container for containing objects and a movable gate, according to some embodiments;

FIG. 4 illustrates a valve on a container for separating objects, according to another embodiment;

FIG. 5 illustrates a plurality of conveyor belts for separating objects, in yet another embodiment;

FIG. 6 illustrates a vibrating conveyor belt for separating objects, according to still another embodiment;

FIG. 7 illustrates a linear actuator, according to another embodiment;

FIG. 8 illustrates an air cannon, in yet another embodiment;

FIG. 9 illustrates a rotary actuator, in still another embodiment;

FIG. 10 illustrates an electromagnet, according to another embodiment;

FIG. 11 illustrates a vibrating device, in still another embodiment;

FIG. 12 illustrates a platform with a plurality of drive wheels, in yet another embodiment;

FIGS. 13A-13B illustrates an object in a container, in still another embodiment;

FIG. 14 illustrates a rotary screen system, according to some embodiments;

FIG. 15 illustrates a screen having rotatable elements according to some embodiments;

FIG. 16 illustrates a screen having elliptical paddles according to some embodiments; and

FIG. 17 illustrates a portion of a screen according to some embodiments.

### DETAILED DESCRIPTION

The present disclosure generally relates to collecting, handling, and/or sorting of waste or other objects. For example, certain embodiments are generally directed to systems and methods for sorting objects such as trash, recyclables, compostables, biodegradables, etc. In some cases, such systems may be used at a MRF (materials recovery facility), a transfer station, a public facility, or other locations where various objects in a waste stream are to be sorted. For example, such systems may be used at an event venue (e.g., stadium) where waste is generated. In some cases, the system may be relatively small and compact. In such cases, the system may occupy a relatively low amount of surface area (e.g., floor space). The waste stream may be singulated or separated into discrete objects to facilitate identification and sorting. For example, two or more discrete objects within the waste stream that are touching and/or contacting one another or are near or proximate to one another may be separated, so as to help facilitate identification and/or sorting of the objects. By organizing the objects using singulation and other techniques, identifying and/or sorting the objects may be less burdensome and/or costly. In some embodiments, organizing the objects may allow for less complex sorting systems. This may be useful, for example, for producing less contaminated streams of trash, recyclables, compostables, biodegradables, etc., Contamination as used herein may refer to materials in a waste stream which are deemed unallowable, such as nonrecyclable items in the recycling waste stream that will ultimately affect the value, cost of processing, or sustainable impact of the desired materials.

Some non-limiting aspects of the present disclosure relate to systems and methods for singulating or separating discrete objects and sorting them. In some cases, singulating or separating objects such that they are not touching and/or contacting one another and/or spaced from one another may facilitate the identification and/or sorting of the objects. For instance, separated objects may be easier to identify and/or to sort in different locations, compared to objects that are in contact or are piled together, etc. In contrast, in many prior art systems, objects are moved through the system at very high rates in an effort to increase throughput, which often results in objects that are piled on top of each other, or are at least are in close contact with each other. This can make it difficult to identify and/or sort the objects. Consequently in many prior art systems, human operators or exceedingly complicated robotic equipment are used to identify or sort the objects.

Existing systems for sorting recyclables are cost prohibitive for various reasons and as such, the inventors have recognized that identifying and sorting recyclables at a reduced cost is desirable. Among the reasons include an excessive quantity of expensive sensors used in existing systems to determine parameters associated with the waste. As such, some of the systems and methods recognized by the inventors described herein may sort and/or identify waste cost effectively. For example, any of the cameras as described herein may be optical range cameras which may reduce costs associated with sensing parameters associated with the waste. As such, the cost associated with identifying and sorting the waste may be reduced in some embodiments.

Some of the systems and methods as described herein may be configured to form a substantially continuous stream of waste that may be identified and/or sorted from a discrete deposition of waste. For example, the system may form a continuous waste stream from a bulk deposition of waste, and the waste stream may be sorted into compostables, recyclables, and/or trash. As such, the systems and methods described herein may serve as an end-to-end solution for identifying and sorting waste in some embodiments.

The systems and methods described herein may involve filtering the objects in the waste stream as a preliminary process in some cases. Filtering may be integrated into the same system with the singulation and/or sorting according to some embodiments. Filtering the objects may help to simplify singulation and/or identification, for example by removing objects that can not be sorted. In some embodiments, the filtering may clean the objects in the waste stream, thereby helping to make identification (e.g., via images) easier. In some embodiments, the system may include one or more screens configured to filter the waste stream. Any appropriate screen may be used in any of the systems and methods described herein, including but not limited to one or more rotary screens, disc screens, elliptical paddle screens, auger screens, any combination thereof, and any other appropriate screen.

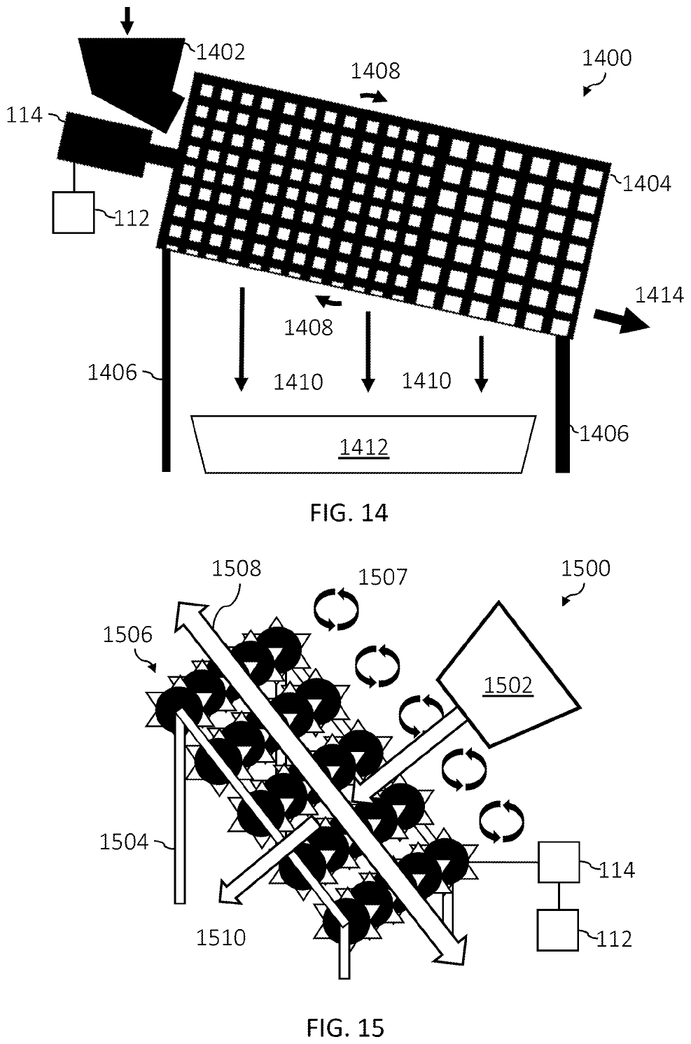

In some embodiments, a screen may include one or more spaced apart rotatable elements configured to rotate and direct objects in the waste stream. The rotatable elements may be formed in any appropriate geometry and in any appropriate configuration. For example, a screen may include rows of rotatable elements arranged and configured to direct objects of the waste stream. In some embodiments, the objects of the waste stream may be disposed and move on top of the rotatable elements relative to a local direction of gravity. The rotatable elements may rotate to move at least a portion of the objects of the waste stream in a first direction. The screen and/or the rotatable elements may be configured to direct different objects of the waste stream in different directions. At least a portion of the objects of the waste stream, such as fine objects described in proceeding paragraphs, may fall through the spaces among the rotatable elements (e.g., directed at least in part by a local force of gravity). The spacing of the rotatable elements may be adjusted to determine which objects fall through the spaces of the rotatable elements. For example, increasing the spacing of the rotatable elements may increase the size of the objects that may fall through the spaces of the rotatable elements. In some embodiments, the rotatable elements may be formed as augers. Optionally, a row of rotatable elements may be formed as a single auger. Further embodiments of the rotatable elements and screens as used herein are described further with respect to FIGS. 14-16 elsewhere.

The screen may include any appropriate quantity of rows of rotatable elements, including at least 1, at least 2, at least 5, at least 10, at least 20, at least 30, at least 50, or any other appropriate quantity of rows of rotatable elements. The rotatable elements may be formed as a cylinder having exterior features. For example, the rotatable element may be formed as a cylinder with one or more blades formed in a spiraling geometry along a longitudinal length of the cylinder. The one or more rotatable elements may be operatively coupled to one or motors and the one or more motors may be configured to rotate the one or more rotatable elements. In some embodiments, the one or more rotatable elements may be rotationally coupled to one another, such that rotating a first rotatable element may rotate one or more other rotatable elements of the screen. In some embodiments, the rows of rotatable elements may be movably coupled such that rotating a first row of rotatable elements rotates a second row of rotatable elements. In some embodiments, the rotatable elements and/or rows of rotatable elements may be rotationally coupled to one another via one or more interlocking gears, belts, chains, shafts, control system, any combination thereof, and any other appropriate coupling configured to coupled movement of one or more rotatable elements.

In some embodiments, fine objects are relatively small objects that may not be sorted due to their size and accordingly may be filtered from the waste stream. Examples of fine objects include grains of sand, grains of rice, liquids, semi-solid food waste, and any other appropriate small objects which may enter a waste stream. Fine objects may include any objects with a volume and/or area below a threshold volume and/or area. For example, any objects with exterior surfaces forming an interior volume, where the interior volume occupies a volume of less 10 cm³ may be fine objects and may be filtered from the waste stream. Objects with an exterior surface area of less than 50 cm² may be fine objects and may be filtered from the waste stream according to some embodiments. Objects with an exterior critical dimension of less than 5 cm may be fine objects and may be filtered from the waste stream according to some embodiments.

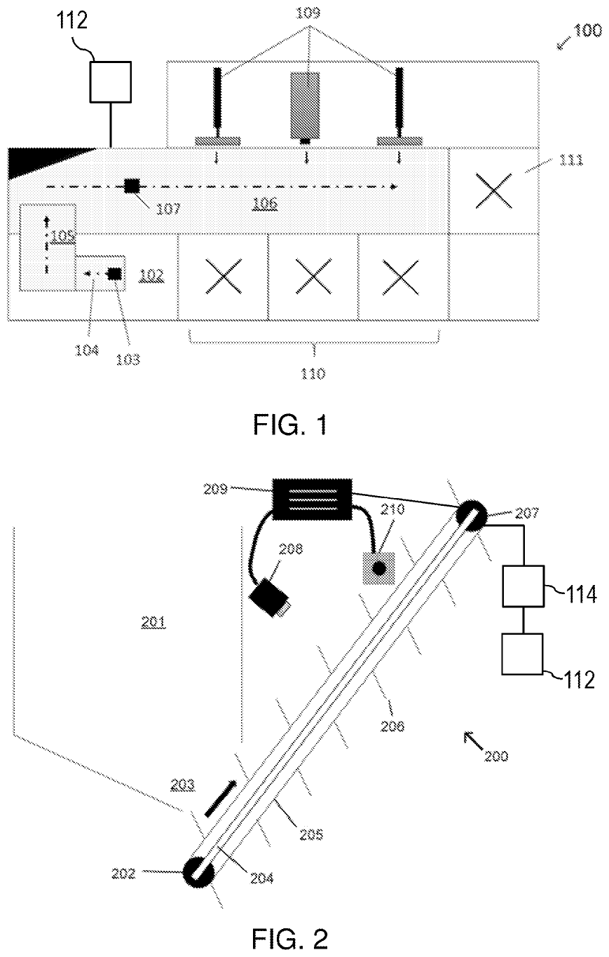

FIG. 1 illustrates a top view of one non-limiting example of a system 100 for singulating or separating objects. The objects may be objects found in a waste stream (e.g., trash, recyclables, compostables, biodegradables, etc.), and/or other appropriate types of objects. In the system 100, a plurality of objects contained within a container 102 are to be sorted into separate locations 110, e.g., based on properties of the objects. As a non-limiting example, if the plurality of objects to be sorted are in a waste stream, glass objects may be sorted into a first location, metal objects may be sorted into a second location, and other objects sorted into a third location, etc. While the depicted embodiment of FIG. 1 shows three boxes indicating three locations, it should be understood that the separate locations 110 may include any appropriate number of locations corresponding to any appropriate number of objects.

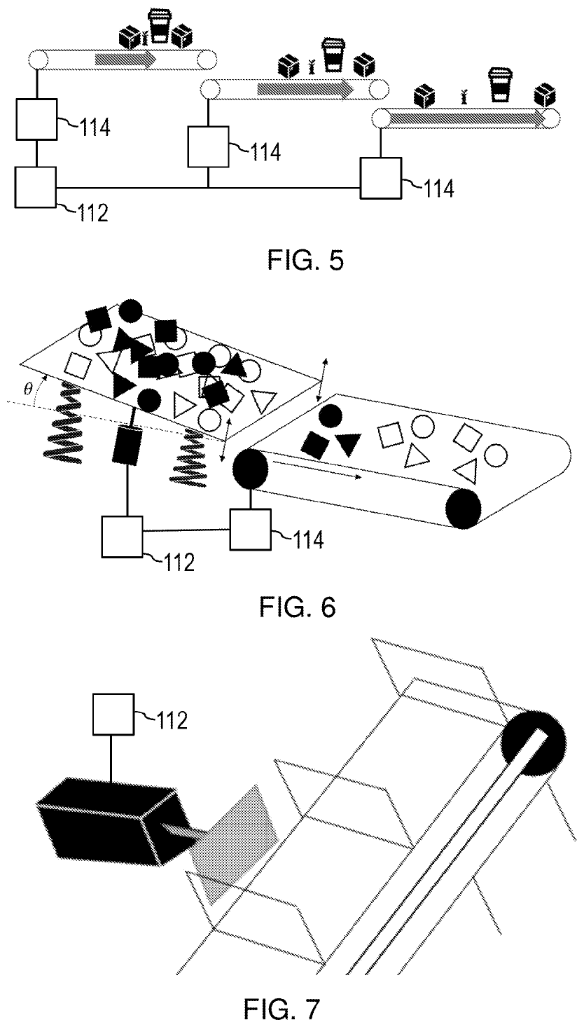

As depicted in the figures, one or more controllers 112 may be configured to control any appropriate portion of the systems described herein. For example, in the depicted embodiment of FIG. 1, the controller 112 may be configured to control the actuators 109, the conveyors belts, any motors, and any other controllable portions. As shown in the depicted embodiment of FIG. 2, a controller 112 may be configured to control one or more motors 114 to turn the conveyor belt. Similarly, the one or more motors as shown in FIGS. 5, 6, and 12 may be controlled with the controller 112. The valve as shown in FIG. 4, and any other valves/gates that may be included in the system may be controlled using a controller such as controller 112. The movable gate 302 may be controlled using controller 112. For example, the controller 112 may control the movable gate 302 to move to open and/or close.

In the depicted embodiment of FIG. 1, objects are contained within a container 102 are singulated or sorted using an inclined belt 104. As discussed below, inclined belt 104 may have one or more collectors disposed thereon which may include cleats, slats, bins, buckets, any combination thereof, and any other appropriate collectors that may form discrete positions to facilitate the collection of objects from container 102. For example, the space between two cleats may define a collector or other discrete location that may contain an object. Although an inclined belt is presented in this example, in other embodiments, other separation apparatuses may be used to separate objects, including those described herein. In this example, the objects are moved via inclined belt 104 out of container 102 such that, objects are present in each collector or other discrete location. In some embodiments, the objects are moved out of the container 102 via the inclined belt 104 one after the other, such that each collector contains one object. These separated or “singulated” objects may then travel via inclined belt 104 to a receiver 105. In the depicted embodiment of FIG. 1, the receiver 105 may be a chute, a transfer belt, a conveyor belt, or any other appropriate structure or mechanism configured to transport objects, to facilitate the transport of objects within the system 100, and/or to facilitate the identification and/or sorting of the objects.

However, in some cases, more than one object may be present within a collector or other discrete location on inclined belt 104 as the disclosure is not limited by the quantity of objects contained within a collector. For instance, two objects may simultaneously be contained within a collector or other discrete location on the inclined belt. In such cases, it may be desirable to identify and reject such objects. For instance, the objects may be moved off inclined belt 104 back into container 102, and/or the objects may be moved to another location, e.g., to be separated, sent to trash, or any other appropriate location.

In one set of embodiments, as shown in FIG. 1, a camera 103 may be used to determine if two or more objects are contacting each other or are otherwise present together, e.g., within a single collector or other discrete location on inclined belt 104. For instance, the objects may not necessarily be in contact, but may be separated by too short of a distance. While a camera is discussed in this non-limiting example, in other embodiments, other sensors (for example, weight sensors, etc.), or any other appropriate photosensitive detectors may be used. If the camera (optionally in conjunction with a computer or controller, etc.) or other sensor determines that two or more objects are in contact with each other or are otherwise present together, then a signal may be sent to cause an action to remedy the situation. For example, a camera may be configured to image an area including one or more objects and a controller may be configured to obtain the image. The controller may be configured to control one or more actuators or other appropriate devices based at least in part on the obtained image. For example, one or more, or all, of the objects may be removed, for instance, using mechanical forces, a flow of gas, vibrations, electrical forces, or the like, and the objects may be returned back to container 102 or directed to another location. As a non-limiting example, a variety of different actuators such as those described herein may be used to remove one or more of the objects, including linear actuators, rotational actuators (e.g., rotary wheels), air cannons, or the like.

Objects that are separated or singulated may pass to a sorting device in the example of FIG. 1. For example, the sorting device may include a conveyor belt 106 that moves the objects past one or more locations 110, which can collect various types of objects. In some embodiments, sorting the objects may include directing the objects to be contained within the one or more locations 110. As an example, objects may be directed to a location using an actuator configured to direct the objects to the location, such as linear actuators 109 in the example of FIG. 1. In some cases, objects that are not sorted (for example, objects not meeting any sorting criteria) may be sent to location 111. In some cases, camera 107 may be used to identify the objects to be sorted. However, it should be understood that a camera is not required, and other sensors (for example, magnetic sensors, etc.) may be used to identify objects for sorting. A variety of sensors are discussed in more detail below.

FIG. 2 illustrates a non-limiting example of a separation apparatus including an inclined belt. As discussed below, however, it should be understood that any other appropriate types of separation apparatuses may be used in the embodiments shown and discussed herein. In the depicted embodiment of FIG. 2, separation apparatus 200 includes an inclined belt 205, which includes a plurality of cleats 206. The cleats 206 are depicted here by way of example only; in other embodiments, bins, buckets, slats, etc. may be used to define collectors or other discrete locations to facilitate the collection of objects. In this figure, objects in container 201 exit through outlet 203 onto inclined belt 205, e.g., at discrete positions on inclined belt 205 defined by cleats 206.

As the objects are moved upwardly on inclined belt 205, they may be imaged using camera 208 which may be operatively coupled to computer 209 in this example. The images may be obtained by the computer, and the computer may determine if two objects are identified as being present within a discrete location based at least in part on the obtained image. The computer may then control actuator 210, or another rejection apparatus, to remove the objects from inclined belt 205. As non-limiting examples, a variety of actuators may be used to remove one or more, or all, of the objects at that location, including actuators such as linear actuators, rotational actuators (e.g., rotary wheels), air cannons, or any other actuators as described herein. It should also be understood that while a single actuator 210 is depicted in FIG. 2, the separation apparatus 200 may include any appropriate types and quantities of actuators configured to remove the objects from the location. Accordingly, separation apparatus 200 may be configured to form a stream of separated or singulated objects, e.g., to be positioned on a receiver for subsequent identification and/or sorting.

Thus, in certain embodiments, a variety of objects, such as waste objects, may be separated or singulated, and the singulated/separated objects may be identified and/or sorted. Such systems and methods may find use in a variety of applications where sorting of objects is required, such as waste handling and sorting, or other applications such as those described herein. However, other embodiments are also possible in addition to the ones shown in FIGS. 1 and 2. Accordingly, more generally, various aspects of the present disclosure are directed to various systems and methods for sorting objects, including for waste handling and sorting applications, as well as other applications.

For example, in certain aspects, a variety of objects or items can be sorted using systems or methods such as those described herein. The objects may include trash, recyclables, compostables, biodegradables, etc., in some embodiments. However, it should be understood that the present disclosure is not limited to these applications, and in other embodiments, other types of objects may be sorted as is discussed herein, such as mail, packaged goods, manufactured components, components for use in manufacturing, items ordered for shipment, groceries, other food products, or the like.

In one embodiment, it may be desirable to sort waste into trash and non-trash objects, such as recyclables, compostables, biodegradables, etc. In some embodiments, it may be desired to sort recyclables by what material the recyclable is formed of, such as paper, glass, metal, plastics, or any other appropriate material. In certain cases, the recyclables may be collected in a suitable recycling container, e.g., in a public location, at curbside, near a residence, etc. and then sorted as discussed herein.

In addition, in some embodiments, the waste may be collected and sorted on-site using systems and methods as discussed herein. This may be useful, for example, in embodiments where it is desirable to pre-sort the waste, e.g., prior to being hauled away. For instance, waste may be collected in a public facility, such as a cafeteria, a stadium, a theater, a mass transit station, a rest stop, a shopping center, a park, a religious center, a restaurant, a strect, community waste collection points, transportation vehicles, residential buildings, venues, stadiums, campuses, businesses, events, etc., and sorted on-site into one or more of trash, recyclables, compostables, biodegradables, etc. However, in other embodiments, the waste may also be sorted off-site.

In some embodiments, the quantity (e.g., volume) of waste produced at the sites mentioned above may be relatively low. This may be advantageous in certain cases. For instance, in some embodiments, waste can be separated or singulated at relatively low rates of processing, which may allow for sorting using a relatively high degree of accuracy. For example, systems configured to process high quantities of waste may include relatively expensive and complicated arrangements of components such as cameras, other sensors, and actuators compared to systems configured to process low quantities of waste. However, it should be understood that in some cases, higher rates of waste processing may be used with any embodiments disclosed herein. In contrast, in many prior art techniques, sorting occurs at relatively high volumes, e.g., such that the waste objects remain in physical contact or are piled together, etc. during the sorting process., and are not separated or singulated before sorting.

In addition, in certain embodiments, the system may be compact and accordingly may have a relatively small “footprint,” or require relatively small amounts of floor space. For example, in some cases, the system may have more than one level disposed at different vertical positions and one or more conveyor belts that may be positioned at non-horizontal angles to facilitate the separation of objects and/or move objects from a first level to a second level. In some embodiments, the levels may be formed with one or more conveyor belts. The system may include more than two levels and associated conveyor belts or any other appropriate movement systems configured to move the objects from one level to another as the disclosure is not limited by the quantity of levels of the system. The system may also include any appropriate quantity of conveyor belts that may be configured to reduce or minimize the space (e.g., floor space) occupied by the conveyor belts and/or the system.

As such, in some embodiments, objects may be directed to any portions of the system as described herein may using a conveyor belt, and the conveyor belt may be configured to reduce the floor space occupied by the system. For example, the conveyor belts may be configured to form turns, such as a 90-degree turn in a substantially L-shape and may be configured to direct objects to follow the direction of the turn. The conveyor belt may be configured to form a turn with any appropriate angle, including any angle from 0 degrees to 90 degrees. The angle may form the conveyor belt to direct the objects in a direction parallel to a horizontal plane which is perpendicular to a local direction of gravity. A conveyor belt having a turn may be configured to direct an object in a first direction which is parallel to the horizontal plane, and may be configured to direct objects moving in the first direction to move in a second direction, which is a turn direction, which is parallel to the horizontal plane and is angled relative to the first direction, where the angle is anywhere from 0 degrees to 90 degrees. The conveyor belts described herein may also be configured to form an angle relative to the horizontal plane as described herein in addition to the conveyor belts including turns as described herein.

In some embodiments, the system may have a footprint of less than 50 m², less than 25 m², less than 20 m², less than 15 m², less than 10 m², less than 8 m², less than 5 m², less than 4 m², less than 3 m², less than 2 m², or less than 1 m². However, the system may have a footprint of any appropriate area as the disclosure is not limited to any footprint. In addition, in some embodiments, the waste may be collected and sorted off-site, rather than on-site, as mentioned. For instance, the waste may be collected and brought to a separate location for sorting. As non-limiting examples, the waste may be brought to a MRF (materials recovery facility), a waste transfer station, a public facility, other waste end-of-life destinations, remote facilities, or other locations, and the waste may be sorted at that location.

A variety of objects may be sorted, including discrete objects. In some cases, the objects may include rigid objects which may have dimensions such as those described herein. However, in some cases, the objects to be sorted may also include objects that are not rigid. For instance, in one set of embodiments, objects that can be sorted include rigid materials, e.g., those that are self-supporting and/or have a relatively defined shape. In contrast, plastic bags or film are not rigid and generally cannot support their own weight. For example, an object which is not rigid such as a plastic bag may have an exterior surface which may elastically deform under a force of gravity to conform to one or more surfaces the plastic bag is disposed on top of.

In some embodiments, waste may be collected and/or sorted into trash and non-trash, which may include recyclables, compostables, and/or biodegradables, etc. The trash may include objects that have not been sorted out of the waste stream, whether intentionally or due to inadvertent sorting errors, etc. In some cases, the trash includes objects that are not recyclable and/or compostable, e.g., due to scientific or economic reasons. However, it should be understood that in some embodiments, the objects sorted and/or identified by the systems and methods described herein may vary. For example, in one embodiment, a system may be designed to remove objects formed of plastics and glass from a waste stream and allow any remaining objects to proceed to trash. In another embodiment, the system may remove objects formed of plastics, glass, metal, and paper from a waste stream and allow any remaining objects to proceed to trash. In yet another embodiment, the system may remove plastics and compostables from the waste stream. In still another embodiment, the system may remove a first type of plastic but not a second type of plastic from the waste stream. For example, the system may be configured to remove plastic objects formed of Polyethylene but not plastic objects formed of Polystyrene. In another embodiment, the system may remove a first shape from a waste stream (e.g., cans) but allow other shapes to proceed to trash. In another embodiment, the system may remove objects manufactured by a particular supplier and allow any remaining objects to proceed. In another embodiment, the system may remove locally reusable objects and allow any remaining objects to proceed. Other sorting criteria are also possible in yet other embodiments, e.g., as discussed herein, including sorting of objects that are not waste or trash (for example, mail).

Waste can be composed of one or more material types including, but not limited to trash, recyclable, and compostable materials. In one set of embodiments, the waste to be sorted includes municipal solid waste (MSW). This may include waste typically found in waste collected from a municipality or a city, e.g., as is commonly thrown away from homes, schools, hospitals, businesses, etc. As examples, MSW may include objects such as product packaging, grass clippings, furniture, clothing, bottles, food scraps, newspapers, appliances, paint, batteries, cardboard boxes, cans, trays, etc. Objects within the MSW can have a variety of characteristics, including being soft, sharp, dirty, clean, stiff, pliable, any combination thereof, and any other appropriate characteristics.

In some embodiments, the MSW may include a variety of recyclables, compostables, and/or biodegradables, in which it is desired that certain objects be removed before the MSW is sent to trash (e.g., to landfill or to energy recycling, etc.). Recyclables generally refers to objects that can be separated and reused or recycled in some manner. Examples of recyclable materials include paper, glass, plastic, and metal. These can be sorted from waste, and then subsequently used, for example, to make new products. Examples of recyclable polymers include, but are not limited to polyethylene terephthalate (PET), high density polyethylene (HDPE), or polypropylene (PP). In some cases, the plastics may be rigid, e.g., as discussed herein. In some embodiments, a waste stream to be sorted may contain a relatively large amount of recyclable objects, e.g., that need to be sorted from non-recyclable objects. For example, in some embodiments, at least 20%, at least 30%, at least 40%, at least 50%, at least 60%, at least 70%, at least 80%, or at least 90% by weight of the waste stream may comprise various recyclables such as paper, glass, metal, plastic, etc. For instance, in some situations, a relatively large amount of the objects put into a waste container may be cans or bottles.

Compostables may be present in certain embodiments. Compostables generally refers to objects that can be broken down into smaller components in a compost pile. Certain compostables may need certain composting environments (e.g., certain microorganisms, heat, and/or humidity levels, for example, ambient temperatures) to decompose by at least 50% within a reasonable amount of time (e.g., generally no more than 2 years or 3 years). Compostables may include certain types of napkins, silverware, cups, plates, bowls, food containers, etc., that are fabricated from certain types of materials and/or according to certain standards. Such materials may include plastics or polymers such as such as polylactic acid, or bagasse (e.g., made from sugar cane fibers). For example, some standard methods for determining compostability of plastics include ASTM D6400 or ASTM D6868. Plastics that are compostable may be fabricated with a variety of compostable materials.

In certain embodiments, biodegradables may be present. Biodegradables are generally termed as objects that can be broken down naturally by microorganisms. In some cases, biodegradables may be broken down on their own, e.g., without human intervention. In some cases, the microorganisms may or may not require an aerobic environment to break down the objects. Some examples of biodegradables include food, grass or yard clippings, butcher resides, dried vegetation, sawdust, sewage, paper, manure, etc. In addition, certain types of plastics may be biodegradables. For instance, polycaprolactone may be a type of plastic that can be a biodegradable in presence of certain microorganisms (e.g., a Thermomyces fungal strain). Generally standard tests may be used in some cases to determine if a plastic or other material may be considered a biodegradable, e.g., ASTM D5988, ASTM D6954-04, etc.

In some cases, the objects that can be sorted may include objects that have a greatest dimension of at least 1 cm, at least 2 cm, at least 3 cm, at least 4 cm, at least 5 cm, at least 6 cm, at least 8 cm, at least 10 cm, at least 12 cm, at least 15 cm, at least 20 cm, etc. The greatest dimension can be determined as the farthest distance that two imaginary parallel planes formed on one or more points or surfaces of the object can be separated from each other. In some cases, the object may have a greatest dimension that is less than 100 cm, less than 80 cm, less than 75 cm, less than 70 cm, less than 60 cm, less than 50 cm, less than 45 cm, less than 40 cm, less than 35 cm, less than 30 cm, less than 25 cm, or less than 20 cm, etc. Combinations of any of these are also possible in certain embodiments. For example, objects that can be sorted may have a greatest dimension of between 15 cm and 75 cm, between 20 cm and 60 cm, between 10 cm and 100 cm, between 5 cm and 50 cm, etc.

It should be understood that the waste stream may also include, in certain embodiments, objects that cannot or otherwise are not sorted, e.g., due to their shape, size, composition, etc. For instance, such objects may be excessively difficult to identify, too small to sort, or may be identified as objects that cannot be sorted. Such objects may instead be sent to trash or to another location.

In some cases, a stream containing a first material type may comprise a certain percentage of other material types, and sorting may be performed to improve the purity of the first material type. For example, a trash stream may contain 70-90% trash (by weight), with recyclables and/or compostable materials that could potentially be sorted out of the trash. As another example, a recyclable stream may contain 50-90% recyclables (by weight), with other materials that could be separated from the recyclables. As still another non-limiting example, a compostable stream may contain 10-50% compostables, with other materials that could be separated from the compostables. It should be understood that the percentages presented in this paragraph are approximations, and the disclosure is not limited to any percentage of material type within a stream. For instance, a container positioned near a soda pop vending machine may have a relatively high percentage of aluminum cans, even if clearly marked as being for trash or landfill.

In one set of embodiments, the objects described herein may be contained within a container of a sorting system. In some cases, the container may be formed with a particular geometry/shape (e.g., rectangular). Other shapes are also possible, including but not limited to, cylindrical, conical, triangular, or any other appropriate shape. Combinations of shapes are also possible. In addition, in some embodiments, the shapes may be chosen to minimize objects from getting stuck or bridging within the container. In some embodiments, bridging may describe when one or more objects may contact one another and one or more interior surfaces of the container to form a structure or bridge. The structure or bridge may prevent the objects in the container from moving or being collected and in some instances may form a jam. For instance, to reduce or eliminate objects being stuck or bridging within the container, the container may have a funnel or a hopper shape. In some cases, the container can be detached or partially detached, e.g., such that it can be cleaned or replaced with a fresh container, such that objects can be added to it, or the like. The container may be formed from any suitable material including but not limited to metal or plastic. For example, in some embodiments, the container may be formed of aluminum sheet metal, plate steel, polypropylene plastic, and/or any other appropriate material.

In some embodiments, the container may have an opening to allow objects to exit, e.g., to be separated as discussed herein. The opening may have different shapes and/or sizes, which may vary depending on the type and/or size of the objects to be sorted. The opening may be used to help facilitate the removal (e.g., unloading) of objects from the container, and/or to begin the process of separating the objects in some embodiments, e.g., due to the shape and/or size of the opening. In some cases, the opening may be completely or partially covered, for example, with a valve, a gate or other adjustable barrier that can be positioned to control or change the size of the opening. In certain cases, this barrier may be movable and operable to alter the separation of the objects within the container.

In some embodiments, the objects can be separated or singulated using a suitable separation apparatus. In some embodiments, the objects may be separated by an average distance. In some embodiments, the distance may represent the lowest distance between any point on an outermost exterior surface of a first object and any point on an outermost exterior surface of a second object. In such embodiments, the distance may be representative of an edge-to-edge distance (e.g., edge of a first object and edge of a second object). In some embodiments, the distance may represent a distance between a center of the first object a center of the second object. The center as referred to herein may be a midpoint of the object along three dimensions. The separation apparatus may be configured to separate objects such that they are not in physical contact with each other. For instance, the objects may become separated such that, on average, they are separated by at least 1 cm, at least 2 cm, at least 3 cm, at least 4 cm, at least 5 cm, at least 6 cm, at least 8 cm, at least 10 cm, at least 12 cm, at least 15 cm, at least 20 cm, at least 25 cm, at least 30 cm, etc. In some embodiments, at least 50%, at least 60%, at least 70%, at least 80%, or at least 90% of the objects separated using the separation apparatus have been separated by the dimensions recited in this paragraph.

The separation apparatus may take a variety of forms. In one embodiment, the separation apparatus may include a conveyor belt that may be positioned at a non-horizontal (e.g., relative to a direction of gravity) angle to facilitate the separation of objects. The angle may be, for example, at least 5°, at least 10°, at least 15°, at least 20°, at least 25°, at least 30°, at least 35°, at least 40°, at least 50°, at least 55°, at least 60°, at least 65°, at least 70°, at least 75°, at least 80°, at least 85°, etc. relative to horizontal. In some embodiments, for instance, the conveyor belt may be positioned at an incline or vertically to collect objects from a container and move them to a receiver. One non-limiting example is shown in FIG. 2. Such a conveyor belt may make it easier for objects to become loaded onto the conveyor belt, or onto collectors on the conveyor belt. However, it should be understood that in other embodiments, the conveyor belt may be horizontal.

Thus, the conveyor belt may define a plurality of collectors, e.g., having discrete positions configured to contain an object. The collectors may be defined, for example, using one or more cleats, slats, bins, buckets, etc., positioned on or attached to the conveyor belt. These may be permanently attached to the conveyor belt, or detachable from the conveyor belt. In some embodiments, these may be positioned orthogonal to an exposed upper surface of the conveyor belt. The orthogonal positioning of the collectors may help to prevent the objects from falling off when undesired, for example from vibrations and gravity directing an object off of the conveyor belt when undesired. For example, a recyclable (e.g., a soda can) may become positioned between two belt cleats, which defines a collector space between the cleats. However, in some cases, these may be positioned in non-orthogonal directions. For example, cleats, slats, bins, buckets, or the like may be at an angle between 45 degrees and 90 degrees in relation to the conveyor belt, or another suitable angle. In addition, in some embodiments, these may be arranged to be evenly spaced or equidistant along a longitudinal length of the conveyor belt (e.g., in a direction of movement of objects traveling on the conveyor belt) from each other to facilitate singulation. However, in some embodiments, the collectors may be spaced at varying distances along the longitudinal length. In some embodiments, spacing the collectors on the conveyor belt at varying distances may help to collect objects of different sizes. This may be useful, for example, to allow a regular flow of objects and/or prevent certain objects (e.g., large objects) from creating jams. In some embodiments, a jam may occur when a movable portion of the system may not move due to an obstruction. The obstruction may be one or more objects preventing movement of one or more movable portions of the system. For example, an object having a relatively large size may not be transferred using the evenly spaced collectors and accordingly having one or more larger spaced collectors may enable a collector to contain and transfer larger objects to transfer the object having the relatively large size.

In some cases, the collectors may be configured (e.g., sized and/or positioned on the conveyor belt) to generally contain a single object, thereby facilitating the separation of objects from the container. In some embodiments, collectors may be defined using cleats, slats, bins, buckets, or the like. For example, the collectors may include spaces between cleats or slats, etc., or the inner portions of bins, buckets, or the like. In some cases, the collectors may be positioned on a conveyor belt at a spacing or periodicity of at least 5 cm, at least 6 cm, at least 8 cm, at least 10 cm, at least 12 cm, at least 15 cm, at least 20 cm, etc. Positioning the collectors with the aforementioned distances may facilitate the collection of single objects on the conveyor belt according to some embodiments. In addition, in certain embodiments, the collectors may be positioned on a conveyor belt so as to define discrete positions having volumes, which may facilitate the collection of single objects on the conveyor belt according to some embodiments. For instance, the collectors may define volumes of less than 100,000 cm³, less than 50,000 cm³, less than 30,000 cm³, less than 10,000 cm³, less than 5,000 cm³, less than 3,000 cm³, less than 1,000 cm³, less than 500 cm³, less than 300 cm³, or less than 100 cm³.

However, it should be understood that objects larger than the collector may still be sorted or manipulated using the collector, in certain embodiments. For example, in FIGS. 13A (front view) and 13B (side view), an object having a width greater than a width of the collector may still contain an object. In some cases, for example, the collector may be able contain objects that have a width of at least 110%, at least 120%, at least 130%, at least 140%, at least 150%, at least 170%, at least 200%, at least 250%, at least 300%, at least 350%, at least 400%, at least 450%, at least 500%, or any other appropriate percentage of the width of the collector. It should be appreciated that objects having a width smaller than the collector may also be contained by the collector.

It should also be understood that the collection of single objects from the container may not necessarily be perfect (e.g., not every object may be singulated or separated in a discrete location). Accordingly, in certain embodiments, if two or more objects are present in a single discrete location, a rejection apparatus such as those discussed herein may be used to remove one or more of those objects.

The conveyor belt may move at a steady or variable rate. In some embodiments, the conveyor belt may move at average speeds of at least 150 cm/min, at least 300 cm/min, at least 450 cm/min, at least 600 cm/min, at least 900 cm/min, at least 1200 cm/min, at least 1500 cm/min, at least 1,800 cm/min, at least 2,400 cm/min, at least 3,000 cm/min, at least 3,600 cm/min, at least 4,200 cm/min, at least 4,800 cm/min, at least 5,400 cm/min, at least 6,000 cm/min, or any other appropriate average speed. In some embodiments, the conveyor belt may move at average speeds of no more than 6,000 cm/min, no more than 5,400 cm/min, no more than 4,800 cm/min, no more than 4,200 cm/min, no more than 3,600 cm/min, no more than 3,000 cm/min, no more than 2,400 cm/min, no more than 1,800 cm/min, no more than 1,500 cm/min, no more than 1,200 cm/min, no more than 900 cm/min, no more than 600 cm/min, no more than 450 cm/min, no more than 300 cm/min, no more than 150 cm/min, or any other appropriate average speed. Combinations of any of these are also possible; for example, the conveyor belt may move at speeds of between 450 cm/min and 4,500 cm/min, between 1,200 cm/min and 1,800 cm/min, between 1,200 cm/min and 2,400 cm/min, or any other appropriate average speed.

The conveyor belt may have any suitable width. For example, the conveyor belt may have an average width of at least 10 cm, at least 15 cm, at least 20 cm, at least 30 cm, at least 40 cm, at least 50 cm, at least 60 cm, at least 70 cm, at least 80 cm, at least 90 cm, at least 100 cm, at least 120 cm, at least 150 cm, at least 200 cm, at least 250 cm, at least 300 cm, at least 350 cm, at least 400 cm, at least 450 cm, at least 500 cm, or any other appropriate width. In addition, in some cases, the conveyor belt may have a width of no more than 500 cm, no more than 450 cm, no more than 400 cm, no more than 350 cm, no more than 300 cm, no more than 250 cm, no more than 200 cm, no more than 150 cm, no more than 120 cm, no more than 100 cm, no more than 90 cm, no more than 80 cm, no more than 70 cm, no more than 60 cm, no more than 50 cm, no more than 40 cm, no more than 30 cm, no more than 20 cm, no more than 15 cm, no more than 10 cm, or any other appropriate width. Combinations of any of these are also possible. As non-limiting examples, the conveyor belt may have an average width of between 5 cm and 60 cm, between 90 cm and 500 cm, between 2 feet and 4 feet, between 90 cm and 150 cm, or any other appropriate width.

The collectors may be designed according to the dimensions of the objects to be collected. This may be useful for a variety of reason, e.g., to improve collection effectiveness and consequently the singulation of objects. In certain embodiments, the longest dimension of an object may be smaller than or equal to the width of the conveyor belt. For instance, the length ratio of the width of the conveyor belt to the greatest dimension of an object may be at least 100%, at least 110%, at least 120%, at least 130%, at least 140% at least 150%, at least 160%, at least 170%, at least 180%, at least 190%, at least 200%, or any other appropriate ratio. However, the length ratio of the width of the conveyor belt to the longest dimension of the object may be remarkably higher, e.g., for significantly smaller objects. For instance, possible length ratios may include no more than 1000%, no more than 900%, no more than 800%, no more than 700%, no more than 600%, no more than 500%, no more than 400%, no more than 300%, or any other appropriate ratio. Any combination of the disclosed ratios are possible, as the disclosure is not limited to the ratio of the width of the conveyor to the greatest dimension of the objects.

It should be understood that the width of the conveyor belt may not necessarily restrict certain objects to be collected based on their size. In some embodiments, the objects may have a longest dimension that is larger than the width of the conveyor belt. For instance, the length ratio of the width of the conveyor belt to the longest dimension of the object may be at least 50%, at least 60%, at least 70%, at least 80%, at least 90%, at least 100%, or any other appropriate ratio. For example, a water bottle may have a greatest dimension (e.g., 10 cm) that is greater than the width of the conveyor belt (e.g., 8 cm), which may yield a length ratio of 80%, but may still be collected and singulated. This may be beneficial for improving singulation of objects while still allowing an efficient collection of objects.

Similarly, one or more dimensions of an object may be greater than the collector depth, such that at least a portion of the object is not contained within and/or overhangs on the collector. The ratio of the collector depth to the one or more dimensions of the object may be at least 50%, at least 60%, at least 70%, at least 80%, at least 90%, at least 100%, or any other appropriate ratio. This may also be useful to improve the collection and singulation of objects. Nonetheless, one or more dimensions of the object may not need to be greater than the collector depth in many cases, e.g., for very small objects (e.g., a candy wrapper).

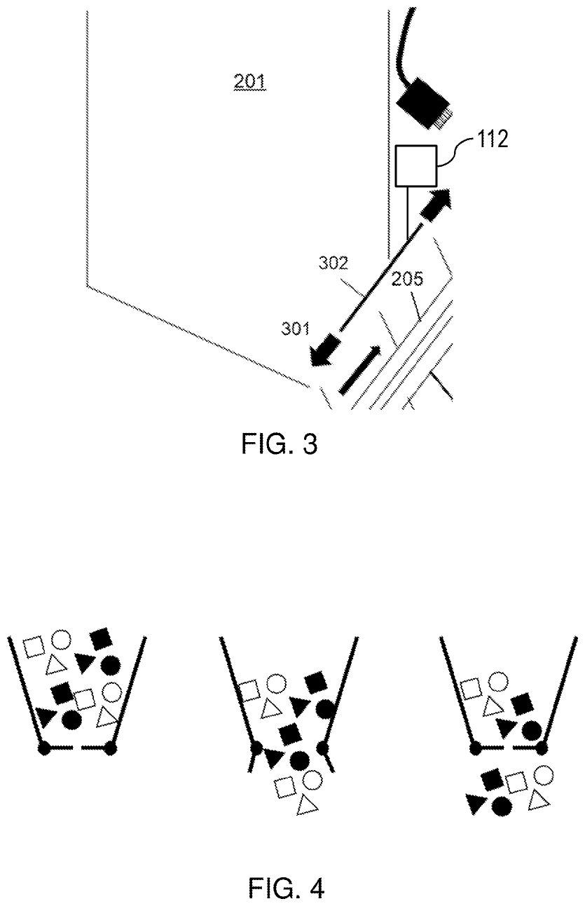

Another non-limiting example of a separation apparatus is shown in FIG. 3. In the depicted embodiment of FIG. 3, an outlet of a container 201 may have a movable gate 302 movably coupled thereto, which may be moved to control a flow of objects out of container 201 to an inclined belt 205. In this example, the moveable gate 302 is coupled to the outlet at an exterior of the container 201, however the moveable gate may be positioned in any other appropriate location. The gate may be positioned upstream or downstream from the flow of objects relative to the container 201. For example, the moveable gate may be positioned upstream from, inside of, or downstream from the outlet of the container. In this example embodiment, the movable gate 302 is a single sluice gate moveable in directions parallel to the arrows 301. For example, the moveable gate may be moveable between an open position and a closed position. The moveable gate may move between the open position and the closed position in a direction parallel to the arrows 302. In further embodiments, other barriers may be used in place of or in conjunction with the single sluice gate, for example, one or more additional sluice gates, any appropriate valves, any other appropriate gates, any combination thereof, or any other appropriate barriers configured to selectively direct the flow of waste. In some cases, there may be one, two, or any appropriate quantity of barriers. The barriers may open, close, or adjust via a hinge, a linear motion, a rotational motion, etc.

For example, in another embodiment, a valve, gate, or other barrier may be at least partially opened and closed in a manner to help separate objects exiting the container. For example, a barrier may be present in a container, and opened or closed to allow one or more objects to pass through, e.g., in a singular manner. For instance, the barrier may be automatically or manually opened and closed corresponding to an interval of time, or to create an opening or outlet of a certain size, or until an object has passed through the opening or outlet, etc., according to some embodiments. One non-limiting example of a valve is shown in FIG. 4, showing a valve that can be controllably opened to allow one (or more) objects to pass through.

In some embodiments, one or more sensors may be configured to sense information associated with the barrier (e.g., a motion sensor, a camera, any appropriate photosensitive detector, a magnetometer, an air pressure sensor, a light sensor, a physical sensor, an accelerometer, etc.). For example, the one or more sensors may be configured to sense an object entering and/or exiting (e.g., passing through) the opening. For example, in one embodiment, a sensor may include a member that may clastically deform when an object contacts the member, which may be indicative that an object has passed through the opening. As another example, a beam of light may be directed to be incident on a light sensor (or any other appropriate photosensitive detector) which may be configured to sense the beam of light when the beam of light is incident on the sensor, and interruption of the beam of light (e.g., by an object traveling through the opening) may indicate that an object has passed through the opening.

In other embodiments, the separation apparatus may have other forms. In one set of embodiments, for example, the separation apparatus may comprise a plurality (e.g., a series) of conveyor belts that may be configured to move with successively increasing speeds. This may allow objects on the belts to become increasingly separated as the objects move between the conveyor belts. For example, a first conveyor belt may move objects at a first speed, and a second conveyor belt which may be configured to receive the objects from the first conveyor belt may move objects at a second speed which is greater than the first speed, which may thereby increase the distance of separation between objects. In some cases, this process may be further repeated to further increase the distance of separation, e.g., the objects may move to a third conveyor belt to move the objects at a third speed which may be greater than the second speed, in some cases to a fourth conveyor belt to move the objects at a fourth speed which may be greater than the third speed, and so on such that any appropriate number of conveyor belts with associated speeds may be used. A non-limiting example of such a system is shown in FIG. 5, with arrows of increasing length indicating increasing speed. The conveyor belts may be unadorned, or in some cases, a conveyor belt may contain bins, cleats, slats, etc. that define collectors or other discrete positions, e.g., as is discussed in more detail herein. The conveyor belts may move at speeds such as those described herein. In addition, the conveyor belts may independently be of the same or different sizes, widths, or other dimensions as discussed herein.

In another embodiment, one or more conveyor belts may be configured to vibrate and/or be tilted or sloped, e.g., such that objects fall off of the conveyor belts in a substantially stochastic manner (e.g., not entirely determined). The objects falling off of the conveyor belts may result in separation of the objects, for example, onto a second conveyor belt or other receiver. The conveyor belts may be vibrated/moved using any appropriate actuator, such as with a vibrating motor, any other appropriate motor, linear actuators, pneumatic actuators, hydraulic actuators, any combination thereof, and any other appropriate actuator as the disclosure is not so limited. A non-limiting example of such a system is shown in FIG. 6, where a plurality of objects disposed on a first conveyor belt (shown as a planar surface) are vibrated or shaken such that they fall off onto a second conveyor belt at various times, thereby creating separation between the objects. In some embodiments, the vibrations may be able to move some objects to singulate the objects. For example, a vibratory device may move or separate objects (e.g., small plastic beads) from other objects (e.g., a glass bottle). In some embodiments, the second conveyor belt may move objects at a speed that is equal to or greater than the speed at which the first conveyor belt moves objects, e.g. to facilitate separation. Examples of suitable speeds of conveyor belts are discussed in more detail herein. The conveyor belts may be unadorned, or in some cases, a conveyer belt may contain bins, cleats, slats, or other collectors that define discrete positions, e.g., as is discussed in more detail herein. In addition, the conveyor belts may independently be of the same or different sizes or widths, etc., for instance, as discussed herein.

In some embodiments, a robotic arm may be used to separate objects. For example, one or more robotic arms may be configured to separate objects in place of or in conjunction with the systems and methods discussed herein. A variety of robotic pickers are known to those of ordinary skill in the art. For example, the robotic picker may be configured to pick objects up from a container and put them on a conveyor belt or other receiver, e.g., at spaced intervals. The robotic picker may comprise an articulated arm, a gantry system, or other suitable configurations. Additionally, more than one separation apparatus may also be used in a sorting system as described herein in certain instances, including one or more of these and/or other separation apparatuses.

In certain embodiments, the separation apparatus may be operated at such a rate so as to allow objects to be separated up at a rate of at least 1 object/min, at least 2 objects/min, at least 3 objects/min, at least 5 objects/min, at least 10 objects/min, at least 15 objects/min, at least 20 objects/min, at least 25 objects/min, at least 30 objects/min, at least 40 objects/min, at least 50 objects/min, at least 60 objects/min, at least 70 objects/min, at least 80 objects/min, at least 90 objects/min, at least 100 objects/min, or any other appropriate rate. In some cases, the rate may be no more than 100 objects/min, no more than 90 objects/min, no more than 80 objects/min, no more than 70 objects/min, no more than 60 objects/min, no more than 50 objects/min, no more than 40 objects/min, no more than 30 objects/min, no more than 25 objects/min, no more than 20 objects/min, no more than 15 objects/min, no more than 10 objects/min, no more than 5 objects/min, no more than 3 objects/min, no more than 2 objects/min, no more than 1 object/min, or any other appropriate rate. Combinations of any of these are also possible. For example, in one set of embodiments, the objects may be separated at a rate of between 30 objects/min and 90 objects/min, between 10 objects/min and 50 objects/min, between 70 objects/min and 100 objects/min, or the like.

As discussed, it should be understood that although the separation of objects is desired, such separation may not always perfectly separate the objects. Accordingly, in some aspects, to improve separation accuracies, the objects may optionally be monitored (for example, using one or more sensors) to determine whether two or more objects are not adequately separated (for example, they may be in contact with each other, or separated by too short of a distance), and if so, in some embodiments, to remove or move the objects. The objects may be removed, may be returned back to the container, directed to another location for additional sorting (for example, human sorting or using more complicated sorting equipment), directed to trash, or directed to any other appropriate location. This may occur at any suitable point, e.g., during the singulation process, and/or after the objects have exited the separation apparatus, for example, when the objects are on a receiver, in various embodiments.

In some embodiments, for instance, objects in contact with each other (e.g., stuck together) may be rejected, e.g., using a suitable rejection apparatus. In some cases, the rejection apparatus may reject an object if singulation cannot be achieved. Different objects may be stuck together such as a waste item (e.g., dirt) inside a recyclable (e.g., a plastic container). Since singulation may not be achieved in this case, the rejection apparatus, in some embodiments, may reject objects that are stuck together.

In addition, in some embodiments, singulation or separation of objects may not be necessary if two or more objects are substantially similar. For example, two or more objects (e.g., a bowl and a lid) may be recyclable together, or the two or more objects may be the same type (e.g., two glass bottles), and thus rejection of the two or more objects is unnecessary. Thus, in some cases, two or more objects may not be rejected if they are substantially similar. Other non-limiting examples of material combinations which may not be rejected include plastic-plastic, metal-metal, glass-glass, paper-paper, trash-trash, and compostable-compostable, etc. The combinations may also involve more than two substantially similar objects.

In some embodiments, one or more sensors may be used to determine whether two or more objects are not adequately separated, e.g., if the objects are in physical contact with each other. A variety of different sensors may be used in various embodiments, for example, cameras, weight sensors, light sensors, etc., e.g., to sense properties associated with the objects such as shape, chemical composition, electrical properties, magnetic properties, thermal properties, optical properties, any combination thereof, and any other appropriate property. In some cases, the sensors may be operatively coupled to and/or in communication (e.g., via electronic communication, radio communication, IR communication, the Internet, etc.) with a computer or a processor for processing. In some embodiments, the computer or processor may be configured to obtain the sensed properties and analyze the sensed properties, and if certain conditions such as one or more thresholds associated with the properties are met (e.g., that two or more objects are detected as being present), then the computer or processor may control a rejection apparatus to remove the objects, as discussed below.

In some embodiments, systems or methods described herein may be automated. Automation may be helpful for a variety of reasons, including reducing human intervention. Reducing human intervention may be useful to reduce errors associated with human operators and to reduce any potential injury operators may sustain while operating the system. In some cases, a rejection system may be an automated rejection system. The automated rejection system may be controlled, for example, by a computer or processor, which may be advantageous for certain aspects, e.g., to control the rejection system remotely. The automated systems or methods may be fully automated or partially automated. For example, a partially automated rejection system may need human assistance when an object (e.g., a plastic bag) gets stuck in the rejection system. In addition, automation may be useful in certain embodiments for allowing a continuous stream of objects to be processed. This may be beneficial for a variety of reasons, including but not limited to, collecting and sorting waste at a fixed place (e.g., a trash bin in a restaurant) without having to move the container which receives the waste.

In some embodiments, one or more photosensitive detectors such as a video camera may be used herein. Other examples of photosensitive detectors include, but are not limited to, visible-light cameras, IR cameras, X-ray cameras, hyperspectral cameras, thermal cameras, or the like. The photosensitive detector may be configured to image at least a portion of any appropriate portion of the sorting system which may include one or more objects, e.g., in a separation apparatus, on a receiver, or in another suitable location within a sorting system. One or more images from the photosensitive detectors may be sent to a computer or a processor for processing, e.g., to identify what object and/or how many objects are present in the image. A variety of image analysis techniques may be used for object identification of an image. Systems for doing so include those available commercially. If two or more objects are present, then the objects may be rejected as discussed herein. In addition, in certain cases, objects may also be identified for rejection, even if present in singular form. For example, an object may be identified as being undesirable for sorting, and may accordingly be rejected. Regardless, it should be understood that the current disclosure is not limited to any specific type, number, arrangement, and/or use of the one or more photosensitive detectors.

However, other sensors can be used in other embodiments, e.g., instead of or in addition to a photosensitive detector. For instance, in one set of embodiments, a weight or mass sensor configured to sense a weight or mass associated with one or more collectors may be used. For example, if the objects are all roughly the same size or weight on a collector, a weight sensor may sense a weight about twice the average weight, or more, which may be indicative that more than one such object is present on the collector. In another set of embodiments, the weight sensor may be set to reject a weight above a certain value (for example, regardless of the number of objects that may be present). One or more weight sensors may be also configured to sense weights associated with any appropriate portion of the system beyond the collector, including the conveyor belts, containers, and/or or any other appropriate portion of the system.

As yet another example, a light sensor (which may be a photosensitive detector) configured to sense a light (e.g., a beam of light) may be used herein. For instance, light shining on a light sensor may be interrupted by objects interacting with the light. In certain embodiments, some patterns of light interruptions (e.g., two interruptions very close to each other, or an unusually long interruption) may indicate that more than one object is present, or that the object is too big or of an undesirable dimension, and thus should be rejected.

In some aspects, objects can be rejected using a suitable rejection apparatus, e.g., objects that are in physical contact with each other or are not adequately separated. In some cases, the rejection of objects may occur based on their properties, e.g., as discussed herein. A variety of rejection apparatuses may be used in various embodiments, for example, to remove objects from the separation apparatus, when the objects are on a receiver, or are in another location within the sorting system. Non-limiting examples include actuators such as linear actuators, rotary actuators (e.g., having one or more blades or rotatable structures), air cannons, mechanical arms, rotary wheels, electromagnets, magnetic actuators, eddy currents, mechanical vibrators and/or any other appropriate actuator. In addition, one or more rejection apparatuses may be present in various embodiments.

The rejection apparatus may be positioned in any suitable position and may be configured in any appropriate configuration to remove objects from the separation apparatus, when the objects are on a receiver, or other location within the sorting system. For instance, the rejection apparatus may be positioned to move objects in a direction that is transverse or orthogonal to the direction of travel of the objects, or in other directions. In addition, one or more objects may be removed. For example, if two or more objects are present, all of the objects may be removed, or all but one of the objects may be removed (e.g., such that the remaining object is no longer in contact with another object) according to some embodiments.

In some embodiments, the rejection system comprises an actuator configured to move objects from a conveyor belt, e.g., as discussed herein. For example, in some cases, the actuator may push one or more objects off of the conveyor belt. The actuator (or other rejection system) may be positioned in any appropriate location and oriented in any appropriate orientation, e.g., transverse to the conveyor belt direction of travel, over the conveyor belt, behind or beneath the conveyor belt, etc.

In some embodiments, a rejection apparatus may include an actuator such as a linear actuator. The actuator may be, for example, an electric, electro-mechanical, mechanical, hydraulic, or pneumatic actuator. In some embodiments, the actuator, may be actuated to move a surface, where the surface may be used to push one or more objects from the separation apparatus. For example, if two or more objects in a discrete location are to be rejected, the actuator may be configured (e.g., positioned and oriented) such that when the objects reach that location, the actuator is actuated to push or separate the objects. For instance, the objects may be separated from one another, and/or one or more of the objects may be removed from sorting, for example, to be returned to a container for sorting, sent to another location for additional sorting (for example, human sorting or using more complicated sorting equipment), sent to trash, or any other appropriate location. The actuator may be positioned at any suitable location within the sorting system. For example, the actuator may be positioned to remove objects from the separation apparatus, or from a receiver or another location. In some cases, the actuator may be positioned under a surface containing the objects, which may push the surface or the objects, e.g., from the separation apparatus. For instance, the actuator may cause random (e.g., stochastic) dispersion or directional tipping of the objects. FIG. 7 illustrates one example of an actuator.

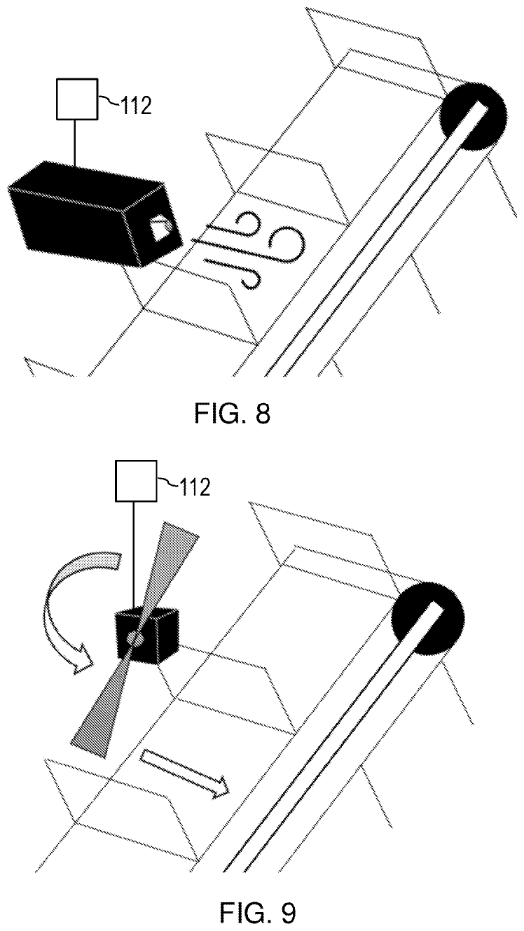

In some embodiments, an air cannon may direct a flow of gas, such as air, towards objects disposed on a separation apparatus and the flow of gas may move the objects off of the separation apparatus. For example, the flow of gas may blow objects off of the separation apparatus. For example, the air cannon may be configured to blow air in a transverse direction of the separation apparatus, although the air cannon may be positioned at any other appropriate angle. In some embodiments, for example, air may come from different angles to push or disperse objects randomly, e.g., during rejection from the separation apparatus. For instance, if the separation apparatus is positioned above a container that contains objects to be sorted, the air may be used to blow objects off the left or the right, thereby separating such objects and returning them to the container as they fall off the separation apparatus. This may be useful in certain embodiments, for example, for removing certain types of objects (e.g., a paper napkin or an aluminum can) that are lighter than others (e.g., a glass bottle). An example of using a flow of gas being directed to the separation apparatus is shown in FIG. 8. However, in other embodiments, the flow of gas may be used to move objects to other locations besides a container.

In some embodiments, one or more mechanical arms may be used to push objects off a separation apparatus. A mechanical arm may be part of a rotary wheel mechanism according to some embodiments. For example, one or more mechanical arms may be rotatably coupled to a motor and the motor may be configured to rotate the one or more mechanical arms. The mechanical arm may be configured to move (e.g., rotate) and push objects off the separation apparatus. In some cases, the mechanical arm may be moved in more than one direction to remove objects. For example, a rotary wheel may be controlled to rotate in a first direction and may be controlled to rotate a second direction. In some embodiments, the rotary wheel mechanism may be controlled at least in part using one or more controllers. The rotary wheel may be turned in any appropriate direction to allow the arms to remove objects off the separation apparatus. One non-limiting example of two mechanical arms rotatably coupled to a rotary wheel mechanism is shown in FIG. 9.

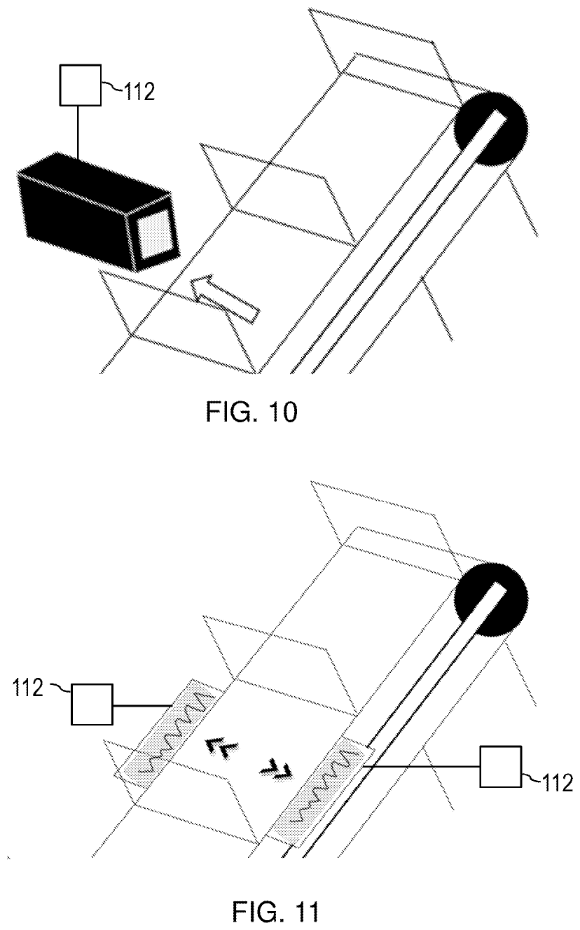

In some embodiments, a magnetic force or an eddy current may be used to push objects off a separation apparatus. For instance, an electromagnet may be used to create a magnetic field including magnetic forces that may that attract or repel an object (e.g., magnetic object), thereby moving the objects from the separation apparatus. As another example, an electrical inductor may be used to create an electric field that attracts or repels objects, thereby moving such objects from the separation apparatus. In some embodiments, such objects may be moved off of the separation apparatus without physically contacting the objects. Accordingly, in some embodiments, objects may be rejected based at least in part on their electric and/or magnetic properties. For example, the rejection apparatus may use a magnetic field and/or an electric field to move objects off a separation apparatus. For instance, an apparatus capable of producing a magnetic field may be able to form magnetic forces with a ferromagnetic object (e.g., a stainless-steel fork) but not with a non-magnetic object (e.g., a glass bowl). One non-limiting example is shown in FIG. 10, where a force acting in direction that may be parallel to the direction indicated by an arrow may move an object off of the separation apparatus. The force may be a magnetic force as described herein.

In another embodiment, mechanical vibrations may be used to disperse objects and/or move them from the separation apparatus. For example, one or more mechanical vibrators may be coupled to any appropriate portion of the separation mechanism and may be activated to vibrate at least a portion of the separation apparatus such that the objects fall off or otherwise exit the separation apparatus. An example of mechanical vibrations can be seen in FIG. 11. In the depicted embodiment of FIG. 11, objects disposed on the conveyor belt may move in directions indicated by the arrows. Also in the depicted embodiment of FIG. 11, two actuators configured to vibrate the conveyor belt as described herein are coupled to opposing sides of the conveyor belt, indicated by the rectangles on either side of the conveyor belt with sinusoidal-like lines within the rectangles. However, it should be understood that any appropriate quantity of actuators may be used in any appropriate configuration. Any appropriate mechanical, electrical, and electromechanical device/actuator may be used herein to form mechanical vibrations, including one or more linear resonant actuators, solenoids, vibration motors, any combination thereof, and any other appropriate actuator as the disclosure is not so limited.

In yet another embodiment, the conveyor belt may itself be used as a separation apparatus. For instance, in some embodiments, objects that are to be separated or rejected may be returned to the container by moving the conveyor belt in a reverse direction. For example, objects may be directed out of the container by moving the conveyor belt in a first direction (e.g., upwards), and may be directed back into the container by moving the conveyor belt in a second direction (e.g., downwards), which may be opposite to the first direction.

After separation or singulation, the objects may be collected on a suitable receiver, e.g., for identification and/or sorting. In some aspects, the receiver may include conveyor belts, slides, chutes, drive wheels, or the like, e.g., to move the objects into locations where sorting may occur. In some embodiments, a receiver may be configured to collect sorted or singulated objects, e.g., from the separation apparatus. In some embodiments, the objects on the receiver may be ready to be identified and/or sorted.

In certain embodiments, a receiver may be used to assist in the singulation of objects. For instance, after an object is transferred from the conveyor belt into the receiver, the receiver may be configured to receive or reject objects based on their singulation status (e.g., singulated or touching another object, etc.). For instance, one set of embodiments may use a receiver (e.g., a transfer belt) that can move forward if the object is singulated and backwards if the object is touching another object.

In one set of embodiments, the receiver may be at a height greater than the container. For example, the receiver may be disposed vertically above the container with respect to a direction of gravity. This may be useful, for example, to produce a more compact system, and/or to facilitate the removal of objects from the separation apparatus and/or rejection apparatus, e.g., due to gravity. For instance, as discussed herein, objects that are rejected may be directed into a container, e.g., that contains other objects to be sorted. In some embodiments, a local force of gravity may help to direct the rejected objects into the container. In addition, in some embodiments, the receiver may be positioned and oriented to facilitate sorting or singulation. A non-limiting example of such a system is shown in FIGS. 1 and 2, where receiver 105 may be positioned at a height greater than the outlet of container 201, and objects within container 201 can be separated and moved to receiver 105 via inclined structural member 204 of the separation apparatus.

In some embodiments, the objects on the receiver may be identified and/or sorted. A variety of methods may be used. For example, in one set of embodiments, image analysis may be used to identify objects on a receiver, e.g., on a conveyor belt (such as conveyor belt 106 in FIG. 1). However, in other embodiments, the objects to be sorted may be present on a chute, a slide, or another suitable surface. For example, a camera may be configured to image one or more objects, the images from the camera may be obtained by a computer, and the computer may be configured to identify the object, the composition of the object (for example, as paper, glass, plastic, metal, food waste, compostables, etc.), and/or any other appropriate analysis. The camera may be, for example, a video camera, a visible-light camera, an IR camera, an X-ray camera, a hyperspectral camera, a thermal camera, or any other appropriate camera or photosensitive detector.

It should be understood that in certain embodiments, as a majority of objects to be sorted have been singulated or separated from other objects, identification of the object to be sorted may be simpler and/or less prone to error, for example, due to the reduction or elimination of multiple and/or overlapping objects that could confound analysis. Multiple and/or overlapping objects may confound analysis by blocking or reducing the obviousness of essential features that may be captured (e.g., imaged) by the sensor for accurate classification and/or sorting of the individual objects. Accordingly, in some embodiments, relatively simple analytical techniques may be used to identify such objects for sorting. In some cases, this may also allow more rapid identification techniques to be used, and/or for greater sorting speeds to be achieved.

Other sensors may be used, e.g., in addition to and/or instead of a camera. For example, in other embodiments, sensors such as weight sensors, light sensors, magnetic sensors, electric sensors, etc., may be used to identify the objects to be sorted. For example, the weight or the size of the object may be determined using a weight sensor or a light sensor, and used to identify the object, etc. In addition the object may be identified using properties such as shape, chemical composition, electrical properties, magnetic properties, thermal properties, and/or optical properties, etc. In some cases, more than one sensor may be used.

After an object is identified, the object may be sorted, for example, using a sorting apparatus. In some embodiments, a first object type may be sorted to a first location, and a second object type may be sorted to a second location. As a non-limiting example, the objects may be sorted into categories or locations based on composition (e.g., recyclable materials), for example, one or more of paper, glass, plastic, metal, etc. In some cases, different plastic types may be sorted into different locations. In some cases, unsorted objects may be sent to a different location, for example, as trash, or for further sorting (e.g., human sorting), etc. As another example, one or more of trash, recyclables, compostables, and biodegradables may be sorted from each other. In still another example, different types of mail may be sorted from each other, e.g., based on size and/or weight.

In some embodiments, identified objects moved to associated locations using a sorting apparatus. The sorting apparatus may, in some embodiments, use actuators, including any actuators described herein. Non-limiting examples of actuators include linear actuators, rotary actuators (e.g., having one or more blades), air cannons, mechanical arms, rotary wheels, electromagnets, magnetic actuators, eddy currents, mechanical vibrators, any combination thereof, any other actuator mentioned herein, and any other appropriate actuator. If more than one actuator is present, e.g., for sorting purposes, the actuators may independently be the same or different. As an example, in FIG. 1, three linear actuators 109 are illustrated, which can independently be operated to direct objects on conveyor belt 106 into separate locations 110. The separate locations may be separate containers that can contain the objects according to some embodiments. As an illustrative non-limiting example, a first container may be used to contain a first type of object (e.g., glass objects), while a second container may be used to contain a second type of object (e.g., metal objects). However, it should be understood that FIG. 1 is non-limiting, and other configurations are possible beyond the embodiment illustrated in FIG. 1.

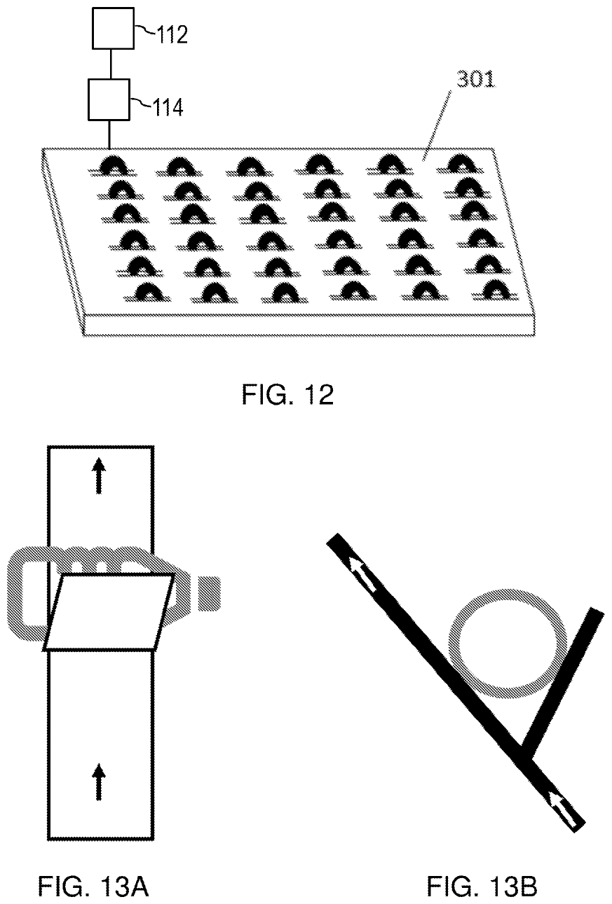

In addition, other sorting apparatuses are contemplated in further embodiments. For example, a plurality of drive wheels may be used to move objects to different locations. In some cases, for instance, a plurality of first wheels may be rotated in a first direction to move an object to a first location, while a plurality of second wheels (or the first wheels) may be rotated in a second direction to move an object to a second location. One non-limiting example of such a system is illustrated schematically in FIG. 12, with a platform containing a plurality of drive wheels, which may be rotated to move objects on the platform in one or more directions, e.g., to different locations. In this figure, an array of independently driven wheels 301 can rotate independently or change direction of travel, e.g., based on suitable sensor data about the object to be sorted. Devices including drive wheels as described herein may be obtained commercially in some instances.

As previously discussed, one or more screens may be configured to filter the waste stream according to some embodiments. Non-limiting examples include rotary screens, drum screens, screens with rotatable elements, gravitational screens, screens having paddles (e.g., elliptical paddles), which may be move at any appropriate angle, or the like.

In some embodiments, a rotary screen may be used to filter the waste stream, such as rotary screen system 1400 as shown in the depicted embodiment of FIG. 14. The rotary screen may include a hopper 1402 configured to receive the waste as described herein. The hopper 1402 may receive waste, indicated by an arrow directed at the top of the hopper. The waste may travel through the hopper 1402 into a drum screen 1404. The drum screen 1404 may be formed as a cylinder and may be configured to rotate according to some embodiments. The drum screen 1404 may rotate in any appropriate direction, including the direction indicated by curved arrows 1408. A motor 114 may be configured to rotate the drum screen 1404 and a controller 112 may be configured to control the motor according to some embodiments. The drum screen 1404 may be structurally supported by one or more supports 1406. The drum screen 1404 may be supported by any appropriate number of supports configured to support the drum screen in any appropriate fashion as the disclosure is not so limited.

The waste stream may travel through the drum screen 1404 as the drum screen rotates. Objects from the waste stream may fall through the drum screen, for example in the direction indicated by the arrows 1410. In some embodiments, the objects may fall from the drum screen in a direction approximately parallel to a local direction of gravity. Optionally, the objects may pass through the drum screen 1404 from the waste stream into one or more containers 1412. The drum screen 1404 may be formed out of a screen configured to allow objects equal to or below a threshold size to pass through (e.g., fall through) the screen, and objects above the threshold size to travel along a length of the drum screen to exit the drum screen, for example in a direction approximately parallel to the arrow 1414. The drum screen may be formed with interlocking structures formed with spaces among the interlocking structures, where the interlocking structures may be formed to form the spaces in desired dimensions. Objects may pass through the spaces as they move through the drum screen.

In some embodiments, the drum screen 1404 may include one or more drum screen portions configured to permit objects of different sizes to pass through the drum screen. For example, a first portion of the drum screen 1404 may have a screen that permits objects of a first size to pass through and a second portion that permits objects of a second size to pass through, where the second size is greater than the first size. For example, as shown in the depicted embodiment of FIG. 14, the drum screen 1404 is formed with a first portion proximate to the hopper 1402 having a finer screen with smaller spaces among the interlocking members than a second portion which is distal from the hopper 1402. Accordingly, relatively smaller objects (e.g., fines) may pass through the first portion of the drum screen 1404 and relatively larger objects may pass through the first portion of the drum screen. It should be appreciated that the drum screen may include any appropriate portions having any appropriate fineness as the disclosure is not so limited. In some embodiments, such as the depicted embodiment of FIG. 14, the drum screen may be angled relative to a local direction of gravity such that objects traveling through the drum screen may move through the drum screen at least in part due to a force of gravity. The drum screen may be formed in any appropriate angle as the disclosure is not so limited.

The waste stream may be filtered using a screen with rotatable elements configured to filter the waste stream. For example, the waste stream may be filtered using a screen having rotatable elements 1500 as shown in the depicted embodiment of FIG. 15. A plurality of rotatable elements 1506 may be arranged to form rows. A row may include one or more rotatable elements 1506. In some embodiments, a row may include a plurality of rotatable elements disposed on a rotatable shaft. The rotatable shaft may be coupled to one or more supports 1504 configured support the rotatable shaft and any rotatable elements 1506 coupled thereto. In the depicted embodiment of FIG. 15, the screen 1500 includes five rows of rotatable elements, and each row of rotatable elements includes five rotatable elements, although the screen may include any appropriate quantity of rows and a row may include any appropriate number of rotatable elements as the disclosure is not so limited. The rotatable elements 1506 may be configured to rotate in any appropriate direction, including the direction indicated by the curved arrows 1507. The rotatable elements may also rotate in a direction opposite to the curved arrows 1507 as the disclosure is not so limited. The rotatable elements may be rotated using one or more motors 114, and the motors may be controlled at least in part using a computer 112 according to some embodiments.

Waste may be directed to the screen with rotatable elements 1500 via an inlet 1502. For example, the waste may be directed onto the rotatable elements 1506 in a direction following the arrow emanating from the inlet 1502. As the rotatable elements 1506 rotate, waste directed onto the rotatable elements may be moved and/or agitated. Moving and/or agitating the waste disposed on the rotatable elements may help to direct at least a portion of the objects to pass through the rotatable elements 1506 and fall below the rotatable elements. According to some embodiments, the objects may pass through the rotatable elements due at least in part to a local direction of gravity. For example, the objects may fall through the rotatable elements in a direction parallel to the arrows 1510 shown in the depicted embodiment of FIG. 15. In some embodiments, the objects passing through the screen 1500 in the direction of the arrows 1510 may be fine objects as described herein.

Portions of the waste disposed on the rotatable elements 1506 may be directed to move in directions parallel to the arrows 1508. For example, a first portion of objects may be directed in a direction parallel to the arrows 1508 up and to the left relative to the perspective of FIG. 15. In some embodiments, the first portion of objects may include objects having a relatively flat geometry such as plastic foil and sheets of paper, paperboard, cardboard, or any other object having a relatively flat geometry. A second portion of objects may be directed in a direction parallel to the arrows 1508 down and to the right relative to the perspective of FIG. 15. In some embodiments, the second portion of objects may include objects having substantial dimensions in three dimensions, such as a can, container, box, or any other appropriate object having dimensions in three dimensions.

In some embodiments, the rotatable elements may be formed to prevent waste from wrapping (e.g., clinging to) the rotatable elements. For example, an easily deformable thin film of plastic may engage could engage with the rotatable elements while the rotatable elements are rotating and may wrap around one or more of the rotatable elements and any members connected thereto. Such wrapping may slow or halt operation of the machine or may damage the system, wasting time and cost, and accordingly preventing such wrapping is desired. As such, the screen having rotatable elements may be formed to prevent wrapping. For example, the rotatable elements may be formed on a rotating shaft with a diameter sufficiently great to prevent wrapping. For example, the diameter of the rotating shaft may be about 5 cm to about 30 cm, or any other diameter as the disclosure is not so limited. In some embodiments, the rotatable elements may be formed as discs, standard star shapes, curved and modified stars, any combination thereof, and any other appropriate rotatable element.

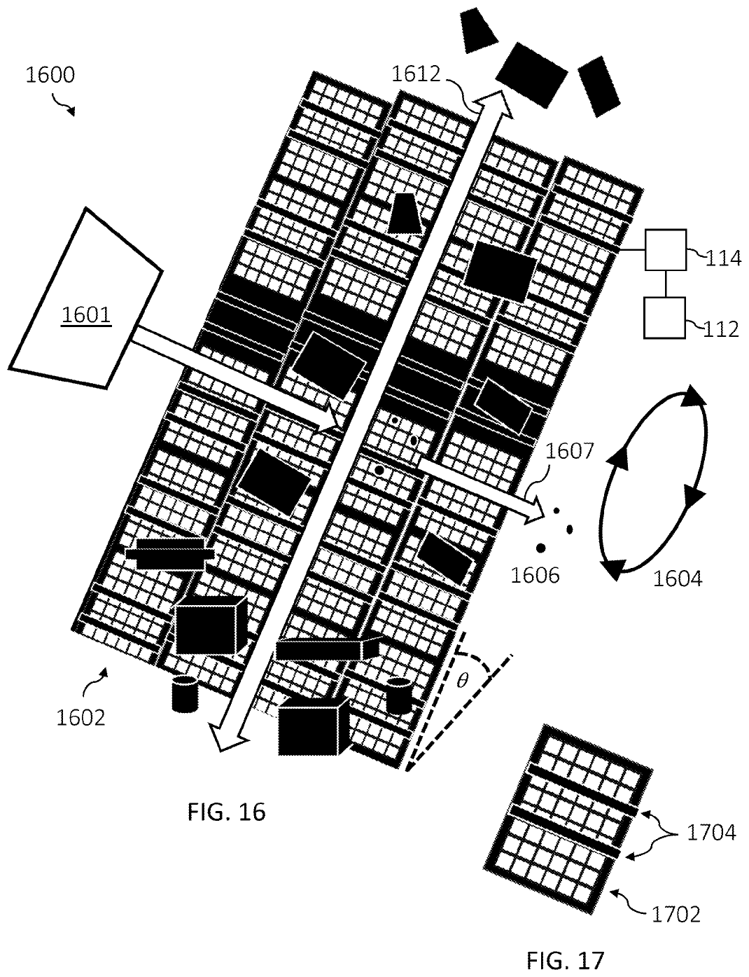

A screen having elliptical paddles 1600 is shown in the depicted embodiment of FIG. 16. An inlet 1601 may be configured to direct waste onto one or more paddles 1602. The one or more paddles 1602 may be configured to move, for example in movement path following an ellipse. The one or more paddles may also be configured to vibrate. An example of the direction of movement of the paddles is shown as an ellipse with arrows indicating the direction of movement 1604. The one or more paddles may be operatively coupled to one or more motors 114, and the one or more motors may be configured to move/rotate the one or more paddles 1602. The one or more motors 114 may also be configured to vibrate the one or more paddles 1602. The one or more motors may be configured to be controlled at least in part using one or more computers 112. In some embodiments, the one or more paddles 1602 may be configured and/or controlled to move independent from one another.

Waste may be directed onto the one or more paddles 1602 via an inlet 1601, for example in a direction parallel to a direction of the arrow emanating from the inlet 1601. The one or more paddles 1602 may include one or more screen portions configured to allow objects from the waste stream to pass through the one or more screen portions. For example, relatively smaller objects 1606 (e.g., fines) may pass through the screen portions of the one or more paddles 1602, optionally in a direction parallel to arrow 1607. Waste disposed on the one or more paddles 1602 may be directed in directions parallel to the arrows 1612. For example, a first portion of objects may be directed in a direction parallel to the arrows 1612 up and to the right relative to the perspective of FIG. 16. In some embodiments, the first portion of objects may include objects having a relatively flat geometry such as plastic foil and sheets of paper paperboard, cardboard, or any other object having a relatively flat geometry. A second portion of objects may be directed in a direction parallel to the arrows 1612 down and to the left relative to the perspective of FIG. 16. In some embodiments, the second portion of objects may include objects having substantial dimensions in three dimensions, such as a can, container, box, or any other appropriate object having dimensions in three dimensions. The second portion of objects may also include relatively heavy objects.

The screen having paddles 1600 moving in an elliptical pattern may be angled at any appropriate angle relative to a ground surface or other surface/plane supporting the screen. For example, the one or more paddles 1602 may be formed at an angle θ (theta) relative to a plane which is substantially perpendicular to a local direction of gravity. The angle θ (theta) may be any appropriate angle, including but not limited to about 10 degrees to about 45 degrees. A paddle of the one or more paddles 1602 may include one or more cleats 1704 as shown in the depicted embodiment of a screen portion of the paddle of FIG. 17. The cleats 1704 may be formed in a transverse direction of the paddle 1602 according to some embodiments. The cleats 1704 may be formed in any appropriate portion of the paddles, including a screen portion 1702. In some embodiments, the screen portion 1702 may be formed to have spaces between interlocking members of about 50 mm by about 50 mm. In some embodiments, the spaces between interlocking members of the screen portion may be formed as approximately square-shaped having the aforementioned dimensions. In some embodiments, the cleats may extend a distance from an upper exposed surface of the paddle of about 6 mm to about 80 mm.

It should be appreciated that any individual screen or combination of screens, such as those depicted in FIGS. 14-17, may be used with any of the systems or methods disclosed herein.

The following examples are intended to illustrate certain embodiments of the present disclosure, but do not exemplify the full scope of the disclosure.

### EXAMPLE 1

This example describes one possible configuration of a waste sorting system capable of processing objects from a waste stream. In some embodiments, the waste sorting system may be configured to process relatively high volumes of a diverse waste stream (e.g., having various object types). With reference to FIG. 1, objects may be received in a container 102. The objects may pass through a separation apparatus as described below to be separated or singulated. In this system, prior to deposition onto conveyor belt 106 for sorting, the singulated objects pass along transfer belt 105, which connects the separation apparatus to conveyor belt 106. While it should be understood that a transfer belt is not necessarily required, in this example configuration, it may be used at least to help make the system more compact (e.g., by occupying a relatively low amount of floor space).

The objects may then be moved onto conveyor belt 106. The objects may be organized to form a row of singulated objects according to some embodiments. Conveyor belt 106 may transport the objects towards unsorted objects bin 111. As the objects move on the conveyor belt 106, the objects may be identified at least in part using camera 107. At least a portion of the conveyor belt may be imaged using the camera 107 and the images may be provided to a computer. The computer may be configured to identify the waste objects based at least in part on the images. Identified waste objects such as recyclable or compostable materials may be directed from the conveyor belt 106 to various sorting bins 110. The objects may be from conveyor belt 106 using actuators 109. The actuators 109 may include one or more actuators of any appropriate type as described herein. Other waste objects, e.g., trash, may not be removed by the actuators 109 and may move past the actuators 109 on conveyor belt 106. Such objects may travel to unsorted bin 111.

FIG. 2 illustrates a separation apparatus where objects may be organized to form a row of singulated objects. The row may be considered a single file or “singulated” stream of waste according to some embodiments. In FIG. 2, an intake hopper 201 may be configured to receive waste and/or other objects from an inlet. In the depicted embodiment of FIG. 2, the inlet is formed as an opening in an upper portion of the intake hopper 201. In some embodiments, the intake hopper 201 may serves as an intermediate storage for the objects that are received by the intake hopper 201. The intake hopper 201 may formed with a volume to allow for sufficient capacity of the objects received by the intake hopper 201, which may vary depending on the application of the separation apparatus. The volume of the intake hopper 201 may be selected based on the application of the separation apparatus, preferably such that the volume of the objects received by the intake hopper do not exceed the volume of the intake hopper.

The objects may exit the intake hopper 201 at an outlet 203. The outlet 203 may direct the objects exiting the intake hopper 201 to an inclined belt 205. The inclined belt 205 (for example, transfer belt 105 or conveyor belt 106 in FIG. 1) may move the objects from the intake hopper 201 to a receiver. In some cases, an angle of the transfer belt 105 relative to horizontal (e.g., perpendicular to a local direction of gravity) may be determined using an inclined structural member 204, which may be positioned to form the angle of inclined belt 205. For example, the inclined belt may be oriented at angle an angle relative to horizontal ranging from about 15 to about 75 degrees, or any other angle from 0 degrees to about 90 degrees. The inclined belt may be controlled, for example, using upper belt roller 207 and/or lower belt roller 202. In some embodiments, one or more motors may be coupled to one or both of the upper belt roller 207 and the lower belt roller 202 and may be configured to rotate the upper belt roller 207 and/or the lower belt roller 202. The inclined belt may move to direct objects upwardly to the receiver.

On inclined belt 205, one or more cleats 206 may be used to contain objects, e.g., in discrete positions corresponding to the cleats 206 on inclined belt 205. Cleats 206 may be formed in any appropriate geometry and configuration. For example, cleats 206 may be angled relative to an upper exposed surface of the conveyor belt or flat. In some embodiments, a cleat may be formed as a fork-like shape or “U” shape. In some embodiments, a cleat may be formed as a rectangle or trapezoid. In some cases, the cleats 206 may keep objects fixed relative to the position of the object to the cleat during transport and/or contribute towards object spacing. In other cases, the cleats 206 may have dynamic components such as independent actuators which facilitate the removal of objects from them. In some embodiments a variety or combination of cleat shapes, cleat angles relative to the inclined belt or cleat styles may be used to facilitate the containing and or removal of objects. In some embodiments, the cleats may be angled relative to the inclined belt, for example, relative to a plane parallel to an upper exposed surface of the inclined belt by any appropriate angle, including but not limited to 0 degrees to 90 degrees. In some embodiments, the cleats may be angled relative to the belt at an angle of about 30 degrees to about 80 degrees. However, it should be understood that the cleats may be formed at any appropriate angle relative to the inclined belt as the disclosure is not so limited.

In some cases, two or more objects may be present within a single discrete location on inclined belt 205. These may be corrected as follows, as one non-limiting example. As shown in the depicted embodiment of FIG. 2, camera 208 may capture images of inclined belt 205, e.g., focusing on the space between two neighboring cleats 206, which may hold objects during transport. The images may be obtained by and analyzed using a computer 209, which may classify the objects based on shape, size, material, any combination thereof, or any other appropriate characteristic associated with the objects. In some cases, the computer may identify cases where more than a single object was collected together in a discrete location. When this occurs, computer 209 may send a signal to actuator 210, or another suitable ejection or correction mechanism. Actuator 210 may remove all but one of the objects, all of the objects, or any other appropriate number of objects, from inclined belt 205. Objects that are removed may be returned to the intake hopper 201, or the objects may be directed to any other appropriate location. However, it should be noted that in other embodiments, the objects may be separated downstream from the inclined belt, e.g., on transfer belt 105 or conveyor belt 106.

U.S. Provisional Application Ser. No. 63/359,062, filed Jul. 7, 2022, is incorporated herein by reference in its entirety.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system, comprising:
a container for containing objects;
a conveyor belt comprising a plurality of collectors, the conveyor belt positioned to collect an object from the container into a collector of the plurality of collectors;
a receiver for receiving the object from the collector, wherein the receiver is at a height greater than an outlet of the container; and
a rejection apparatus for preventing two or more objects contained within the collector from being received by the receiver.

2. The system of claim 1, wherein the container has an outlet for moving objects onto the conveyor belt.

3. The system of any one of claim 1 or 2, wherein the conveyor belt is positioned at a non-horizontal angle.

4. The system of any one of claims 1-3, wherein the conveyor belt is vertically positioned.

5. The system of any one of claims 1-4, wherein the plurality of collectors are defined by a plurality of cleats coupled to and disposed on the conveyor belt.

6. The system of any one of claims 1-5, wherein the plurality of collectors are formed as a plurality of bins on the conveyor belt.

7. The system of any one of claims 1-6, wherein the collectors have an average volume of less than 3000 cm³.

8. The system of any one of claims 1-7, wherein the receiver comprises a conveyor belt.

9. The system of any one of claims 1-8, wherein the receiver comprises a chute.

10. The system of any one of claims 1-9, further comprising a sensor configured to determine objects within a collector of the plurality of collectors.

11. The system of claim 10, further comprising a processor in communication with the sensor and the rejection apparatus.

12. The system of any one of claim 10 or 11, wherein the sensor comprises a camera configured to image the collector.

13. The system of claim 12, wherein the camera is a visible light camera.

14. The system of claim 12, wherein the camera is an infrared camera.

15. The system of claim 12, wherein the camera is an X-ray camera.

16. The system of claim 12, wherein the camera is a hyperspectral camera.

17. The system of claim 12, wherein the camera is a thermal camera.

18. The system of any one of claims 1-17, wherein the rejection apparatus is configured to remove objects from the collector.

19. The system of any one of claims 1-18, wherein the rejection apparatus comprises an actuator configured to remove the objects from the collector.

20. The system of claim 19, wherein the actuator is a linear actuator.

21. The system of claim 19, wherein the actuator is an electric actuator.

22. The system of claim 19, wherein the actuator is a hydraulic actuator

23. The system of claim 19, wherein the actuator is a pneumatic actuator.

24. The system of claim 19, wherein the actuator is a rotary actuator.

25. The system of any one of claims 1-24, wherein the rejection apparatus comprises an air cannon.

26. The system of any one of claims 1-25, wherein the rejection apparatus comprises an electromagnet.

27. The system of any one of claims 1-26, wherein the rejection apparatus comprises an electrical inductor.

28. The system of any one of claims 1-27, wherein the rejection apparatus comprises a vibrating device.

29. The system of any one of claims 1-28, further comprising a sorting apparatus for sorting the objects from the receiver.

30. The system of claim 29, wherein the sorting apparatus comprises a sorting sensor for identifying the objects.

31. The system of claim 30, wherein the sensor comprises a sorting camera configured to image the objects.

32. The system of claim 31, wherein the sorting camera is a visible light camera.

33. The system of claim 31, wherein the sorting camera is an infrared camera.

34. The system of claim 31, wherein the sorting camera is an X-ray camera.

35. The system of claim 31, wherein the sorting camera is a hyperspectral camera.

36. The system of claim 31, wherein the sorting camera is a thermal camera.

37. The system of any one of claims 29-36, wherein the sorting apparatus comprises an actuator for sorting objects into locations.

38. The system of any one of claims 1-37, wherein the system is able to sort at least 30 objects/min.

39. The system of any one of claims 1-38, wherein the system is able to sort at least 50 objects/min.

40. The system of any one of claims 1-39, wherein the system is able to sort at least 90 objects/min.

41. The system of any one of claims 1-40, wherein the objects comprise trash.

42. The system of any one of claims 1-41, wherein the objects comprise recyclables.

43. The system of claim 42, wherein the recyclables comprise glass.

44. The system of any one of claim 42 or 43, wherein the recyclables comprise plastic.

45. The system of any one of claims 42-44, wherein the recyclables comprise paper.

46. The system of any one of claims 42-45, wherein the recyclables comprise metal.

47. The system of any one of claims 1-46, wherein the objects comprise compostables.

48. The system of claim 47, wherein the compostables comprise compostable organic material.

49. The system of any one of claims 1-48, wherein the objects comprise biodegradables.

50. A system, comprising:
a container for containing objects;
a conveyor belt comprising a plurality of collectors having an average volume of less than 5,000 cm³, the conveyor belt positioned to collect objects from the container into a collector of the plurality of collectors;
a camera positioned to image the collectors containing the objects;
a processor in communication with the camera for determining a number of objects within the collector; and
a rejection apparatus for removing objects from the collector if the processor determines two or more objects within the collector.

51. The system of claim 50, wherein the conveyor belt is positioned at a non-horizontal angle.

52. The system of any one of claim 50 or 51, further comprising a receiver configured to receive the objects from the collector.

53. The system of claim 53, wherein the receiver is disposed at a vertical position that is greater than a vertical position of an outlet of the container.

54. A method, comprising:
containing recyclables within a container;
collecting the recyclables within a plurality of collectors on a conveyor belt;
rejecting the recyclables in collectors containing two or more recyclables therein;
conveying non-rejected recyclables in the collectors to a receiver, wherein the receiver is at a height greater than an outlet of the container; and
sorting the non-rejected recyclables.

55. The method of claim 54, further comprising moving the rejected recyclables to the container.

56. The method of any one of claim 54 or 55, further comprising sensing the recyclables within the plurality of collectors, and rejecting the recyclables based on the sensing.

57. The method of any one of claims 54-56, wherein the conveyor belt is non-horizontal.

58. The method of any one of claims 54-57, wherein the plurality of collectors are formed as a plurality of cleats.

59. The method of any one of claims 54-58, wherein the plurality of collectors are formed as a plurality of bins.

60. The method of any one of claims 54-59, wherein sorting the non-rejected recyclables includes sorting at least 30 objects/min.

61. A method, comprising:
containing recyclables within a container;
collecting the recyclables within a plurality of collectors on a conveyor belt, the collectors having an average volume of less than 5,000 cm³;
rejecting the recyclables in collectors containing two or more recyclables therein; and
sorting the non-rejected recyclables.

62. The method of claim 61, further comprising moving the rejected recyclables to the container.

63. The method of any one of claim 61 or 62, further comprising sensing the recyclables within the plurality of collectors, and rejecting the recyclables based on the sensing.

64. The method of any one of claims 61-63, wherein the conveyor belt is non-horizontal.

65. The method of any one of claims 61-64, wherein sorting the non-rejected recyclables includes sorting at least 30 objects/min.

66. A method, comprising:
containing recyclables within a container, wherein at least 50% by weight of the recyclables are cans or bottles;
spacing the recyclables on a receiver to physically separate the recyclables such that 90% are separated by at least 5 cm;
acquiring images of the recyclables on the receiver; and
sorting the recyclables based on their images.

67. The method of claim 66, wherein spacing the recyclables includes using a separation apparatus to space the recyclables.

68. The method of claim 67, wherein the separation apparatus comprises a rejection apparatus for separating two or more objects in contact with one another.

69. The method of any one of claim 67 or 68, wherein the separation apparatus comprises a non-horizontal conveyor belt comprising a plurality of collectors.

70. The method of any one of claims 67-69, wherein the separation apparatus comprises a robotic arm.

71. The method of any one of claims 67-70, wherein the separation apparatus comprises a first conveyor belt moving at a first speed and a second conveyor belt moving at a second speed.

72. The method of any one of claims 67-71, wherein the separation apparatus comprises a vibrating conveyor belt.

73. A method, comprising:
containing waste within a container, wherein at least 50% by weight of the waste are recyclables comprising glass, metal, or plastic;
singulating the recyclables from the container onto a receiver;
acquiring images of the recyclables on the receiver; and
sorting the recyclables based on their images.

74. The method of claim 73, wherein at least 70% by weight of the waste are recyclables comprising glass, metal, or plastic.

75. The method of any one of claim 73 or 74, comprising singulating the recyclables using a non-horizontal conveyor belt comprising a plurality of collectors.

76. The method of any one of claims 73-75, comprising singulating the recyclables using a robotic arm.

77. The method of any one of claims 73-76, comprising singulating the recyclables using a first conveyor belt moving at a first speed and a second conveyor belt moving at a second speed.

78. The method of any one of claims 73-77, comprising singulating the recyclables using a vibrating conveyor belt.

79. A system, comprising:
a container for containing objects;
a conveyor belt comprising a plurality of collectors, wherein the conveyor belt is configured to collect one or more objects from the container into a collector of the plurality of collectors;
a receiver configured to receive the one or more objects from the collector, wherein the receiver is disposed at a vertical position that is greater than an outlet of the container; and
a rejection apparatus, wherein the rejection apparatus is configured to selectively prevent the one or more objects contained within the collector from being received by the receiver.

80. The system of claim 1, wherein the rejection apparatus is configured to prevent the one or more objects contained within the collector from being received by the receiver when the one or more objects includes two or more objects.

81. The system of claim 79, wherein the rejection apparatus is configured to prevent the one or more objects contained within the collector from being received by the receiver when the one or more objects includes two or more objects.

82. A system, comprising:
a container for containing objects;
a conveyor belt comprising a plurality of collectors having an average volume of less than 5,000 cm³, wherein the conveyor belt is configured to collect objects from the container into a collector of the plurality of collectors;
a camera configured to image one or more collectors of the plurality of collectors containing the objects;
a rejection apparatus configured to selectively remove objects from the one or more collectors; and
a processor configured to:
obtain images from the camera;
determine a number of objects within the one or more collectors based at least in part on the obtained images; and
control the rejection apparatus to remove objects from the one or more collectors if the number of objects is two or more.

83. The method of any one of claim 54 or 55, wherein sensing the recyclables within the plurality of collectors includes sensing a number of recyclables within the plurality of collectors, and rejecting the recyclables based on the number of recyclables.

84. A method, comprising:
containing recyclables within a container, wherein at least 50% by weight of the recyclables are cans or bottles;
spacing the recyclables on a receiver to physically separate the recyclables such that at least 90% of the recyclables are separated by at least 5 cm;
acquiring images of the recyclables on the receiver; and
sorting the recyclables based at least in part on the images.

85. The method of any claim 61 or 82, wherein the plurality of collectors have an average volume of less than 3,000 cm³.

86. The system of claim 50, wherein the plurality of collectors have an average volume of less than 3,000 cm³.
